(19) United States
(12) Patent Application Publication
(10) Pub. No.: US 2013/0087458 A1
(43) Pub. Date: Apr. 11, 2013

(54) MICRO-ASSAY CHIP, ASSAY DEVICE USING SAID MICRO-ASSAY CHIP AND PUMPING METHOD

(71) Applicants: Michinobu Mieda, Osaka-shi (JP); Toshiaki Kitagawa, Osaka-shi (JP)

(72) Inventors: Michinobu Mieda, Osaka-shi (JP); Toshiaki Kitagawa, Osaka-shi (JP)

(73) Assignee: SHARP KABUSHIKI KAISHA, Osaka-shi, Osaka (JP)

(21) Appl. No.: 13/700,975

(22) PCT Filed: Apr. 20, 2011
(86) PCT No.: PCT/JP2011/059760

§ 371 Date: Nov. 29, 2012

(30) Foreign Application Priority Data
Jun. 1, 2010 (JP) 2010-126164

(51) Int. Cl. G01N 27/447

(52) U.S. Cl. CPC G01N 27/44791
USPC 204/451; 204/601

(57) ABSTRACT

A microanalysis chip includes: a main flow channel (1) having one end connected to an open hole (7) open to an outside; a first introduction flow channel (2) through which a first liquid (40) is introduced into the main flow channel (1); a first discharge flow channel (3) through which a first liquid (40) introduced into the main flow channel (1) is discharged; and a reacting and detecting section (13) which, inside of the main flow channel (1), analyzes a property of the first liquid (40) introduced into the main flow channel (1), the first introduction flow channel (2) and the first discharge flow channel (3) being both provided at a side of the main flow channel (1) that is opposite to the open hole (7) with respect to the reacting and detecting section (13). Therefore, a solution is quantitatively weighed out with a simple configuration, and the solution thus weighed out is analyzed with the solution kept charged into a flow channel.

### TECHNICAL FIELD

The present invention relates to microanalysis chips for use in microchemical analyses of biological substances, substances in natural environments, etc. More specifically, the present invention relates to a microanalysis chip having a liquid transfer structure capable of causing a liquid to flow by capillary force and quantitatively handling a liquid.

### BACKGROUND ART

Immunoassay methods are known as important analysis or measurement methods in the medical field, the biochemical field, the field of measurement of allergens and the like, etc. However, conventional immunoassay methods are cumbersome and complicated in terms of operation and, what is more, require one or more days for analysis.

Under such circumstances, there has been proposed a microanalysis chip (hereinafter referred to as “analysis chip” as needed) that is obtained by forming, in a substrate, a micrometer-order flow channel (hereinafter abbreviated as “micro flow channel” or simply as “flow channel”) in which an antibody or the like is immobilized.

In the case of an analysis that is carried out by using such an analysis chip, it is necessary to carry out a series of steps of introducing solutions into a detecting section or a reacting section through liquid introduction holes and introduction flow channels, causing the solutions to react with each other in the analysis chip, and discharging the solutions through liquid discharge holes and discharge flow channels.

Conventionally, the transfer of a solution (liquid transfer) in an analysis chip has been carried out by using an external source of power such as a pump or a valve. However, since such a pump or a valve is lager in size than an analysis chip, it has been difficult to overall downsize an analysis device including an analysis chip. There has been proposed a method of disposing comparatively a small-sized micropump or microvalve inside or outside of an analysis chip. However, this method requires complicated fine processing technology, and as such, lacks in practicality.

On the other hand, as a simple method for transferring a solution in an analysis chip, there has been proposed a technology based on the capillary force of a hydrophilic flow channel (e.g., see Patent Literature 1). FIG. 15 shows an example of an analysis chip based on capillary force. In such an analysis chip, a solution dropped into a liquid inlet 401 can flow through a flow channel 402 by capillary force and be discharged through a liquid outlet 403 without requiring external force such as a pump.

Further, in the case of an analysis that is carried out by using an analysis chip, accurate analytical results can be obtained by quantitatively handling the solution used. However, in the case of an analysis chip, the volume of the solution used is extremely small. This makes it difficult to quantitatively weigh out the solution, requires various complex configurations for quantitatively weighing out the solution, and makes an operation for handling the configurations cumbersome and complicated.

As a method for quantitatively weighing out a solution, there has been proposed a method for confine a liquid according to the capacity of a flow channel (e.g., see Patent Literature 2).

As another method for quantitatively weighing out a solution, there has been proposed a method based on centrifugal force (e.g., see Patent Literature 3).

### CITATION LIST

Patent Literature 1
Japanese Patent Application Publication No. 2006-220606 A (Publication Date: Aug. 24, 2006)
Patent Literature 2
Japanese Patent Application Publication No. 2002-357616 A (Publication Date: Dec. 13, 2002)
Patent Literature 3
Japanese Patent Application Publication No. 2005-114438 A (Publication Date: Apr. 28, 2005)
Patent Literature 4
Japanese Patent Application Publication No. 2000-297761 A (Publication Date: Oct. 24, 2000)

### SUMMARY OF INVENTION

### Technical Problem

However, neither of the technologies described in Patent Literatures 2 and 3 listed above can make it possible to carry out an analysis in a flow channel by quantitatively weighing out a solution without use of an external device. As for the technologies described in Patent Literatures 1 and 4, neither of Patent Literatures 1 and 4 mentions a point of view of carrying out an analysis by quantitatively weighing out a solution, although Patent Literatures 1 and 4 mention a point of view of controlling the transfer of a liquid through a flow channel.

A basic structure of a flow channel for use in weighing as proposed in Patent Literature 2 is described here with reference to FIG. 18. As shown in FIG. 18, the flow channel is structured to include a first flow channel 410, a second flow channel 411, and a third flow channel 412.

With use of the flow channel thus structured, a liquid introduced into the first flow channel 410 is pulled into the third flow channel 412 by a capillary phenomenon through an opening in the third flow channel 412, and then a liquid remaining in the first flow channel 410 is removed and a liquid remaining in the third flow channel 412 is pushed out into the second flow channel 411, whereby a liquid of a volume corresponding to the capacity of the third flow channel 412 is weighed.

However, for carrying out an analysis by taking out the liquid thus weighed, it is necessary to remove the liquid remaining in the first flow channel 410 and push out the liquid remaining in the third flow channel 412 into the second flow channel 411. Therefore, with the flow channel structure of Patent Literature 2, it is difficult to take a weighed liquid only with a liquid transfer method based on capillary force and it is necessary to use an external source of power such as a pump. This makes it difficult to overall downsize an analysis device.

Meanwhile, according to the technology described in Patent Literature 3, a solution is introduced into a weighing tube by centrifugal force, whereby a liquid of a volume corresponding to the capacity of the weighing tube is weighed.

This method requires an external rolling mechanism and, what is more, requires an external source of power such as a pump for liquid transfer. This makes it difficult to overall downsize an analysis device.

The present invention has been made in view of the foregoing problems, and it is an object of the present invention to provide a microanalysis chip capable of quantitatively weighing out a solution with a simple configuration and, while keeping a flow channel charged (filled) with the solution thus weighed out, analyzing the solution.

### Solution to Problem

In order to solve the foregoing problems, a microanalysis chip of the present invention includes: a main flow channel having one end connected to an open hole open to an outside; a first introduction flow channel through which a solution is introduced into the main flow channel; a first discharge flow channel through which a solution introduced into the main flow channel is discharged; and an analyzing section provided in the main flow channel so as to analyze a property of the solution introduced into the main flow channel, the first introduction flow channel and the first discharge flow channel being both provided at a side of the main flow channel that is opposite to the open hole with respect to the analyzing section.

According to the foregoing configuration, a solution is introduced into the main flow channel through the first introduction flow channel, and is charged into a space between one end of the main flow channel and the open hole. In so doing, the liquid, having reached the open hole, stops on forming a gas-liquid interface of any of the following shapes (i) to (iii), depending on the degree of hydrophobicity or hydrophilicity of flow channel inner surfaces leading to the open hole: (i) a convex shape slightly projecting in dome form because of the surface tension of the solution; (ii) a substantially planar shape; and (iii) a concave shape whose central portion is slightly depressed in small-plate form.

It should be noted here that the first introduction flow channel and the first discharge flow channel are both provided at a side of the main flow channel that is opposite to the open hole with respect to the analyzing section. Therefore, only a specific amount of a solution that is charged into a space extending from an end of the analyzing section that is closer to the first introduction flow channel to the open hole passes through the analyzing section, and a portion of the solution other than the specific amount of the solution does not pass through the analyzing section.

Therefore, in the case of an analysis that is carried out by using a plurality of microanalysis chips, the amount of a solution that passes through the analyzing section (amount of a solution for analytical use) can be made constant even if the amount of a solution that is introduced varies from one microanalysis chip to another.

It should be noted here that as mentioned above, the first introduction flow channel and the first discharge flow channel are both provided at a side of the main flow channel that is opposite to the open hole with respect to the analyzing section. Therefore, a solution that is introduced through the first introduction flow channel after the charging of the solution is directly discharged through the first discharge flow channel without passing through the analyzing section.

Further, the solution in the main flow channel is ultimately discharged without remaining in the main flow channel.

All this makes it possible to quantitatively weigh out a solution with a simple configuration and, while keeping a flow channel charged with the solution thus weighed out, analyze the solution.

Further, this also brings about a secondary effect of, while keeping constant the amount of a solution for analytical use, introducing and/or discharging a solution.

The term “analysis” here means identification of a substance, detection of a substance, or qualitative or quantitative identification of a chemical composition. In this specification, the term “analysis” encompasses identification of a substance that is produced by a chemical reaction, detection of such a substance, or identification of a chemical composition. Accordingly, the “analyzing section” may be constituted solely by a detection section that carries out only detection, or may be constituted by a combination of such a detection section and a reacting section that causes a chemical reaction.

Further, in order to solve the foregoing problems, a method for transferring a solution of the present invention is a method for transferring a solution by using a microanalysis chip including (i) a main flow channel having one end connected to an open hole open to an outside, (ii) an introduction flow channel having one end connected to a flow channel inner surface of the main flow channel and having formed at the other end thereof a liquid introduction hole into which a solution to be introduced into the main flow channel is poured, (iii) a discharge flow channel through which a solution introduced into the main flow channel through the introduction flow channel is able to be discharged, and (iv) an analyzing section provided in the main flow channel so as to analyze a property of the solution introduced into the main flow channel, the introduction flow channel and the discharge flow channel being both provided at a side of the main flow channel that is opposite to the open hole with respect to the analyzing section, the method including: an introducing step of pouring a solution into the liquid introduction hole and introducing, through the introduction flow channel into the main flow channel, the solution thus poured; a charging step of charging, into a space extending from the one end of the main flow channel to the open hole, the solution introduced into the main flow channel in the introducing step; a first discharging step of discharging a solution remaining in the liquid introduction hole; and a second discharging step of discharging the solution charged into the space extending from the one end of the main flow channel to the open hole.

The foregoing method makes it possible in the charging step to charge, into a space extending from one end of the main flow channel to the open hole, the solution introduced into the main flow channel in the introducing step. In so doing, the solution, having reached the open hole, stops on forming, because of its surface tension, a gas-liquid interface of any one of the aforementioned shapes.

It should be noted here that the introduction flow channel and the discharge flow channel are both provided at a side of the main flow channel that is opposite to the open hole with respect to the analyzing section. Therefore, in each of the introducing, first discharging, and second discharging steps, only a specific amount of a solution that is charged into a space extending from an end of the analyzing section that is closer to the introduction flow channel to the open hole passes through the analyzing section, and a portion of the solution other than the specific amount of the solution does not pass through the analyzing section.

Therefore, in the case of an analysis that is carried out by using a plurality of microanalysis chips, the amount of a solution that passes through the analyzing section (amount of a solution for analytical use) can be made constant even if the amount of a solution that is introduced varies from one microanalysis chip to another.

All this makes it possible to quantitatively weigh out a solution and, while keeping a flow channel charged with the solution thus weighed out, analyze the solution.

Further, this also brings about a secondary effect of, while keeping constant the amount of a solution for analytical use, introducing and/or discharging a solution.

Further, in order to solve the foregoing problems, a method for transferring a solution of the present invention is a method for transferring a solution by using a microanalysis chip including (i) a main flow channel having one end connected to an open hole open to an outside, (ii) a first introduction flow channel having one end connected to a flow channel inner surface of the main flow channel and having formed at the other end thereof a first liquid introduction hole into which a solution to be introduced into the main flow channel is poured, (iii) a first discharge flow channel through which a solution introduced into the main flow channel through the first introduction flow channel is able to be discharged, (iv) a first switching valve provided in the first discharge flow channel so as to regulate a flow of a solution, (v) a second introduction flow channel having one end connected to the flow channel inner surface of the main flow channel and having formed at the other end thereof a second liquid introduction hole into which a solution to be introduced into the main flow channel is poured, (vi) a second switching valve provided in the second discharge flow channel so as to regulate a flow of a solution, and (vii) an analyzing section provided in the main flow channel so as to analyze a property of the solution introduced into the main flow channel, the first introduction flow channel and the first discharge flow channel being both provided at a side of the main flow channel that is opposite to the open hole with respect to the analyzing section, the method including: a first introducing step of pouring solutions into the first liquid introduction hole and the second liquid introduction hole, respectively, and introducing, through the first introduction flow channel into the main flow channel, the solution poured into the first liquid introduction hole; a first charging step of charging, into a space between the one end of the main flow channel and the open hole, the solution introduced into the main flow channel in the first introducing step; a first discharging step of, by opening the first switching valve to facilitate discharge of the solution introduced into the main flow channel, discharging a solution remaining in the first liquid introduction hole; a second discharging step of discharging the solution charged into the space extending from the one end of the main flow channel to the open hole; a second introducing step of, by closing the first switching valve and opening the second switching valve, introducing, through the second introduction flow channel into the main flow channel, the solution poured into the second liquid introduction hole; and a second charging step of charging, into the space extending from the one end of the main flow channel to the open hole, the solution introduced into the main flow channel in the second introducing step.

According to the foregoing method, the first introducing and first charging steps are identical to the aforementioned introducing and discharging steps, respectively. In the first discharging step, after a solution is charged into the main flow channel and stops, for example, a portion of the solution that remains in the first liquid introduction hole is discharged through the first discharge flow channel by opening the first switching valve.

Further, as mentioned above, the first introduction flow channel and the first discharge flow channel are both provided at a side of the main flow channel that is opposite to the open hole with respect to the analyzing section. Therefore, in the second discharging step, the solution charged into the main flow channel is discharged without remaining in the main flow channel.

Next, in the second introducing step, a solution is introduced into the main flow channel through the second introduction flow channel by opening the second switching valve provided in the second introduction flow channel. At this time, the amount of a solution that passes through the analyzing section in the main flow channel is constant regardless of the amount of the solution that is introduced through the second introduction flow channel.

This makes it possible to quantitatively weigh out a solution and, while keeping a flow channel charged with the solution thus weighed out, analyze the solution.

Further, this also brings about a secondary effect of, while keeping constant the amount of a solution for analytical use, introducing and/or discharging a solution.

Further, in order to solve the foregoing problems, a method for transferring a solution of the present invention is a method for transferring a solution by using a microanalysis chip including (i) a main flow channel having one end connected to an open hole open to an outside, (ii) a first introduction flow channel having one end connected to a flow channel inner surface of the main flow channel and having formed at the other end thereof a first liquid introduction hole into which a solution to be introduced into the main flow channel is poured, (iii) a first discharge flow channel through which a solution introduced into the main flow channel through the first introduction flow channel is able to be discharged, (iv) a first switching valve provided in the first discharge flow channel so as to regulate a flow of a solution, (v) a second introduction flow channel having one end connected to the flow channel inner surface of the main flow channel and having formed at the other end thereof a second liquid introduction hole into which a solution to be introduced into the main flow channel is poured, (vi) a second switching valve provided in the second discharge flow channel so as to regulate a flow of a solution, (vii) a third introduction flow channel having one end connected to the flow channel inner surface of the main flow channel and having formed at the other end thereof a third liquid introduction hole into which a solution to be introduced into the main flow channel is poured, (viii) a third switching valve provided in the third discharge flow channel so as to regulate a flow of a solution, and (ix) an analyzing section provided in the main flow channel so as to analyze a property of the solution introduced into the main flow channel, the first introduction flow channel and the first discharge flow channel being both provided at a side of the main flow channel that is opposite to the open hole with respect to the analyzing section, the third introduction flow channel being provided at a side of the main flow channel that is opposite to the first discharge flow channel with respect to the analyzing section, the method including: a first introducing step of pouring solutions into the first liquid introduction hole, the second liquid introduction hole, and the third liquid introduction hole, respectively, and introducing, through the first introduction flow channel into the main flow channel, the solution poured into the first liquid introduction hole; a first charging step of charging, into a space extending from the one end of the main flow channel to the open hole, the solution introduced into the main flow channel in the first introducing step; a first discharging step of, by opening the first switching valve to facilitate discharge of the solution introduced into the main flow channel, discharging, through the first discharge flow channel, a solution remaining in the first liquid introduction hole; a second discharging step of discharging the solution charged into the space extending from the one end of the main flow channel to the open hole; a second introducing third switching valve, introducing, through the third introduction flow channel into the main flow channel, the solution poured into the third liquid introduction hole; a second charging step of charging, into the space extending from the one end of the main flow channel to the open hole, the solution introduced into the main flow channel in the second introducing step; a third discharging step of, by opening the first switching valve, discharging, through the first discharge flow channel, the solution charged in the second charging step and a solution remaining in the third liquid introduction hole; and a third introducing step of, by closing the first switching valve and opening the second switching valve, introducing, through the second introduction flow channel into the main flow channel, the solution poured into the second liquid introduction hole.

According to the foregoing method, a solution is introducing into the main flow channel through the first introduction flow channel in the first introducing step, and is charged into a space between one end of the main flow channel and the open hole. In so doing, the solution, having reached the open hole, stops on forming, because of its surface tension, a gas-liquid interface of any one of the aforementioned shapes.

After that, in the first discharging step, the solution remaining in the first liquid introduction hole is discharged through the first discharge flow channel by opening the first switching valve. Further, as mentioned above, the first introduction flow channel and the first discharge flow channel are both provided at a side of the main flow channel that is opposite to the open hole with respect to the analyzing section. Therefore, after that, in the second discharging step, the solution charged into the main flow channel is discharged without remaining in the main flow channel.

Next, by closing the first switching valve and opening the third switching valve provided in the third introduction flow channel, the solution is introduced into the main flow channel through the third introduction flow channel, and is charged into the main flow channel.

After that, in the third discharging step, by opening the first switching valve, the solution charged into the main flow channel is discharged through the first discharge flow channel without remaining in the main flow channel.

Next, by opening the second switching valve provided in the second introduction flow channel, the solution is introduced into the main flow channel through the second introduction flow channel, and stops after being charged into the main flow channel.

The foregoing configuration makes it possible to transfer three solutions in sequence and to carry out a quantitative analysis of two solutions in the same amounts of the solutions.

This makes it possible to quantitatively weigh out a solution with a simple configuration and, while keeping a flow channel charged with the solution thus weighed out, analyze the solution.

Further, this also brings about a secondary effect of, while keeping constant the amount of a solution for analytical use, introducing and/or discharging a solution.

Further, the technology described in Patent Literature 1 and the microanalysis chip of the present invention are both technologies that relate to mechanisms for controlling the movement of fluids though flow channel spaces. However, unlike the microanalysis chip of the present invention, the technology described in Patent Literature 1 does not at all present a point of view of carrying out an analysis by quantitatively weighing out a solution.

Further, the technologies described in Patent Literatures 2 and 3 and the microanalysis chip of the present invention are both technologies that quantitatively weigh out solutions by utilizing flow channels. However, the technology described in Patent Literature 2 does not present at all a point of view of carrying out an analysis and the like in an analysis chip.

Meanwhile, whereas the technology described in Patent Literature 3 is designed to rotate an analysis chip by using a predetermined rolling mechanism and quantitatively weigh out a solution by utilizing the centrifugal force of the rolling mechanism, the microanalysis chip of the present invention does not require such a rolling mechanism.

Further, the technology described in Patent Literature 4 differs from the microanalysis chip of the present invention in that the former needs to include a micropump. Further, unlike the microanalysis chip of the present invention, the technology described in Patent Literature 4 does not at all present a point of view of carrying out an analysis by quantitatively weighing out a solution.

### Advantageous Effects of Invention

As described above, a microanalysis chip of the present invention includes: a main flow channel having one end connected to an open hole open to an outside; a first introduction flow channel through which a solution is introduced into the main flow channel; a first discharge flow channel through which a solution introduced into the main flow channel is discharged; and an analyzing section provided in the main flow channel so as to analyze a property of the solution introduced into the main flow channel, the first introduction flow channel and the first discharge flow channel being both provided at a side of the main flow channel that is opposite to the open hole with respect to the analyzing section.

Further, as described above, a method for transferring a solution by using a microanalysis chip of the present invention includes: an introducing step of pouring a solution into the liquid introduction hole and introducing, through the introduction flow channel into the main flow channel, the solution thus poured; a charging step of charging, into a space extending from the one end of the main flow channel to the open hole, the solution introduced into the main flow channel in the introducing step; a first discharging step of discharging a solution remaining in the liquid introduction hole; and a second discharging step of discharging the solution charged into the space extending from the one end of the main flow channel to the open hole.

Further, as described above, a method for transferring a solution by using a microanalysis chip of the present invention includes: a first introducing step of pouring solutions into the first liquid introduction hole and the second liquid introduction hole, respectively, and introducing, through the first introduction flow channel into the main flow channel, the solution poured into the first liquid introduction hole; a first charging step of charging, into a space between the one end of the main flow channel and the open hole, the solution introduced into the main flow channel in the first introducing step; a first discharging step of, by opening the first switching valve to facilitate discharge of the solution introduced into the main flow channel, discharging a solution remaining in the first liquid introduction hole; a second discharging step of discharging the solution charged into the space extending from the one end of the main flow channel to the open hole; a second introducing step of, by closing the first switching valve and opening the second switching valve, introducing, through the second introduction flow channel into the main flow channel, the solution poured into the second liquid introduction hole; and a second charging step of charging, into the space extending from the one end of the main flow channel to the open hole, the solution introduced into the main flow channel in the second introducing step.

Further, as described above, a method for transferring a solution by using a microanalysis chip of the present invention includes: a first introducing step of pouring solutions into the first liquid introduction hole, the second liquid introduction hole, and the third liquid introduction hole, respectively, and introducing, through the first introduction flow channel into the main flow channel, the solution poured into the first liquid introduction hole; a first charging step of charging, into a space extending from the one end of the main flow channel to the open hole, the solution introduced into the main flow channel in the first introducing step; a first discharging step of, by opening the first switching valve to facilitate discharge of the solution introduced into the main flow channel, discharging, through the first discharge flow channel, a solution remaining in the first liquid introduction hole; a second discharging step of discharging the solution charged into the space extending from the one end of the main flow channel to the open hole; a second introducing step of, by closing the first switching valve and opening the third switching valve, introducing, through the third introduction flow channel into the main flow channel, the solution poured into the third liquid introduction hole; a second charging step of charging, into the space extending from the one end of the main flow channel to the open hole, the solution introduced into the main flow channel in the second introducing step; a third discharging step of, by opening the first switching valve, discharging, through the first discharge flow channel, the solution charged in the second charging step and a solution remaining in the third liquid introduction hole; and a third introducing step of, by closing the first switching valve and opening the second switching valve, introducing, through the second introduction flow channel into the main flow channel, the solution poured into the second liquid introduction hole.

This brings about an effect of making it possible to quantitatively weigh out a solution with a simple configuration and, while keeping a flow channel charged with the solution thus weighed out, analyze the solution.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a set of diagrams (a) through (f) showing a structure of a microanalysis chip according to an embodiment of the present invention, (a) showing the structure of the microanalysis chip as seen from a side of the microanalysis chip through which a liquid is poured, (b) being a cross-sectional view of the structure of the microanalysis chip as taken along the line X-Y, (c) through (e) each schematically showing the shape of a gas-liquid interface of a liquid having reached an open hole, (f) showing an example of a position of connection of a first introduction flow channel to a main flow channel as seen from the side through which a liquid is poured.

FIG. 2 is a set of structural drawings (a) and (b) respectively showing structures of substrates constituting the microanalysis chip, (a) showing a structure of a first substrate, (b) showing a structure of a second substrate.

FIG. 3 is a set of process drawings (a) through (e) showing the flow of solutions in the microanalysis chip, (a) showing the appearance of a second liquid poured into a second liquid introduction hole, (b) showing the appearance of a first liquid charged into the main flow channel, (c) and (d) showing the appearance of the first liquid being discharged through a first liquid discharge flow channel, (e) showing the appearance of the second liquid charged into the main flow channel.

FIG. 4 is a plan view showing a structure of a microanalysis chip according to another embodiment of the present invention.

FIG. 5 is a set of structural drawings (a) and (b) respectively showing structures of substrates constituting the microanalysis chip, (a) showing a structure of a first substrate, (b) showing a structure of a second substrate.

FIG. 6 is a set of process drawings (a) through (i) showing the flow of solutions in the microanalysis chip, (a) showing the appearance of second and third liquids poured into second and third liquid introduction holes, respectively, (b) showing the appearance of a first liquid charged into the main flow channel, (c) and (d) showing the appearance of the first liquid being discharged through a first liquid discharge flow channel, (e) showing the appearance of the third liquid charged into the main flow channel, (f) showing the appearance of the third liquid being discharged through a second liquid discharge flow channel, (g) showing the appearance of the second liquid charged into the main flow channel, (h) and (i) showing the flow of solutions in the microanalysis chip in a case where the microanalysis chip has a single liquid discharge flow channel.

FIG. 7 is a set of diagrams (a) and (b) showing a structure of a microanalysis chip according to still another embodiment of the present invention, (a) showing the structure of the microanalysis chip as seen from a side of the microanalysis chip through which a liquid is poured, (b) being a cross-sectional view of the structure of the microanalysis chip as taken along the line X-Y.

FIG. 8 is a set of structural drawings (a) and (b) showing a structure of the microanalysis chip, (a) showing a structure of a flow channel forming layer (an intermediate layer) of the microanalysis chip, (b) showing a structure of a third substrate.

FIG. 9 is a structural drawing showing a structure of a microanalysis chip according an example of the present invention.

FIG. 10 is a structural drawing showing a structure of a microanalysis chip according another example of the present invention.

FIG. 11 is a conceptual diagram of portable handy microanalysis device according to another embodiment of the present invention.

FIG. 12 is a structural diagram showing a structure of a microanalysis chip according to a comparative example.

FIG. 13 is a structural drawing showing a structure of a microanalysis chip according to another comparative example.

FIG. 14 is a graph showing results of an experiment carried out on the dependence on the amount of a sample of adiponectine.

FIG. 15 is a structural drawing showing an example of a flow channel structure based on capillary force.

FIG. 16 is a structural drawing showing an example of a flow channel structure based on an electrowetting valve.

FIG. 17 is a set of schematic views (a) through (d) for explaining the operation of an electrowetting valve, (a) showing a state of the electrowetting valve in a case where no voltage is applied between electrodes, (b) showing a state of the electrowetting valve in a case where a voltage has been applied between the electrodes, (c) showing the appearance of a droplet of water in the case of a small contact angle, (d) showing the appearance of a droplet of water in the case of a large contact angle.

FIG. 18 is a structural drawing showing an example of a flow channel structure that quantitatively weighs out a solution.

### DESCRIPTION OF EMBODIMENTS

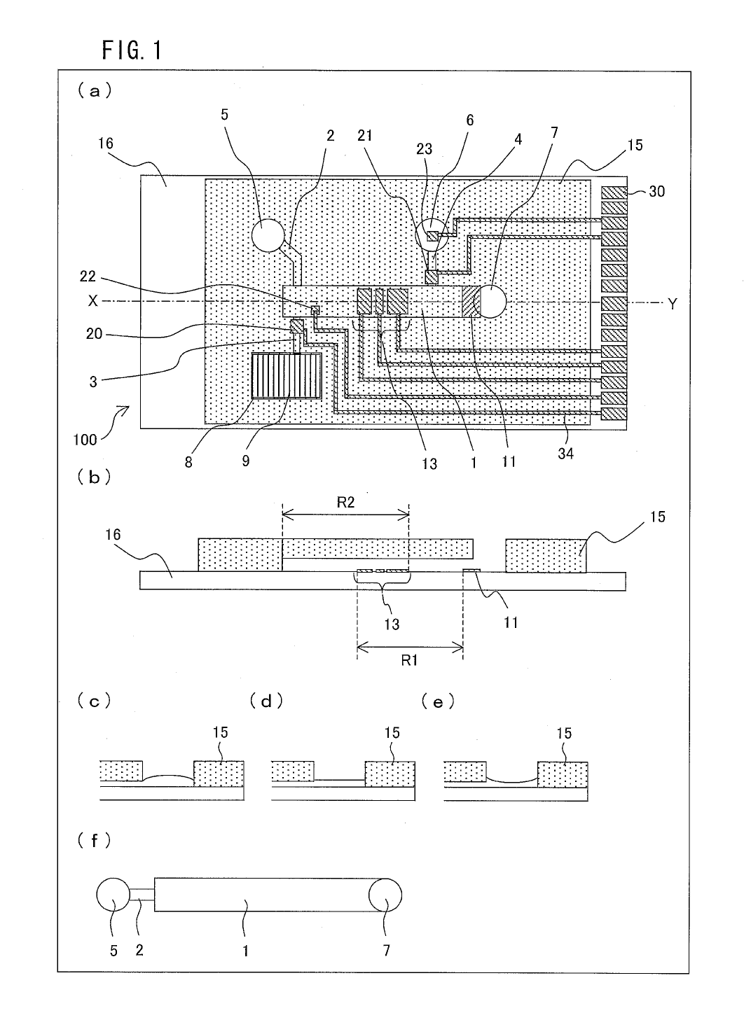

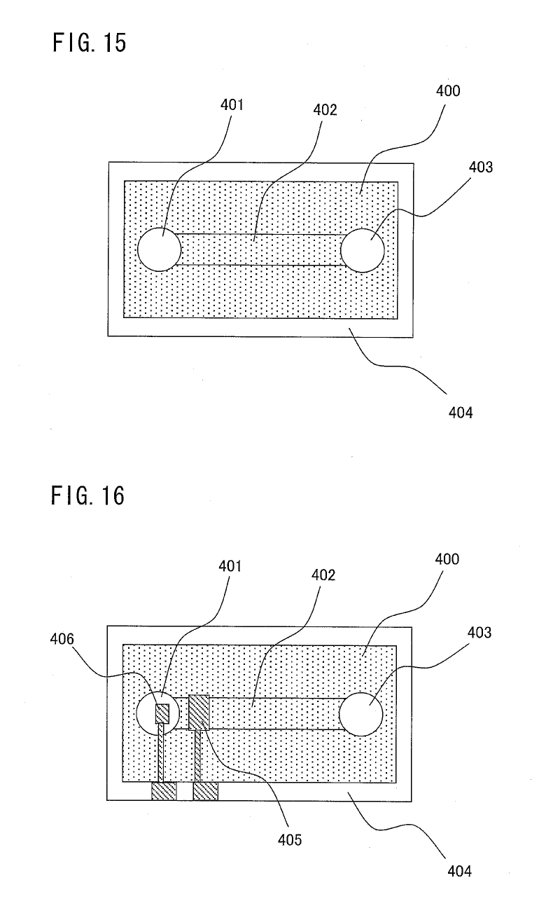

An embodiment of the present invention is described below with reference to FIGS. 1 through 18. Components other than those which are described in the specific embodiments below may be omitted from the description as needed, but are the same as those which are described in other embodiments. Further, for convenience of explanation, members having the same functions as those described in the embodiments are given the same reference signs, and a description thereof is omitted as needed.

### Embodiment 1

### Configuration of a Microanalysis Chip 100)

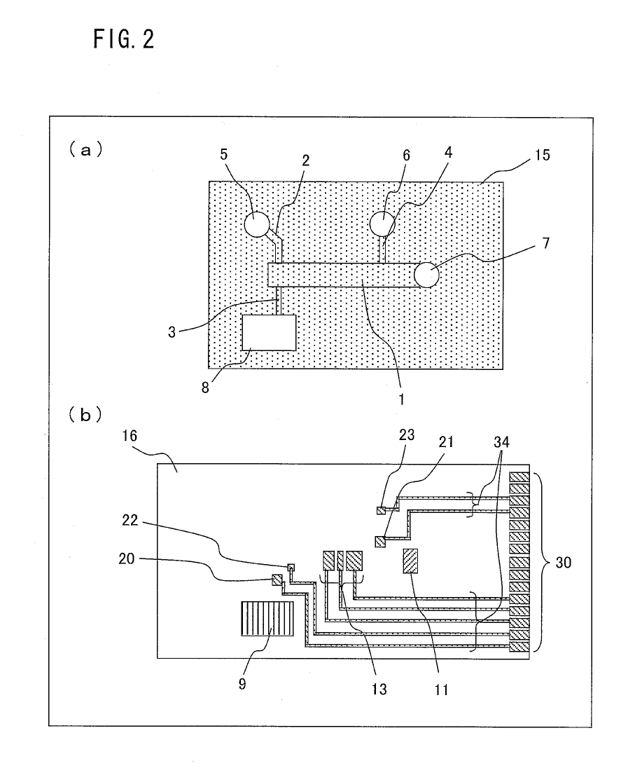

A configuration of a microanalysis chip 100 according to Embodiment 1 is described with reference to FIGS. 1 and 2. (a) of FIG. 1 shows a structure of the microanalysis chip 100 as seen from a side of the microanalysis chip 100 through which a liquid is poured, and (b) of FIG. 1 is a cross-sectional view of the structure of the microanalysis chip 100 as taken along the line X-Y shown in (a) of FIG. 1.

As shown in (a) of FIG. 1, the microanalysis chip 100 includes a main flow channel 1, a first introduction flow channel (introduction flow channel) 2, a first discharge flow channel (discharge flow channel) 3, a second introduction flow channel 4, a first liquid introduction hole (liquid introduction hole) 5, a second liquid introduction hole 6, an open hole 7, a first liquid-discharging section 8, an absorber 9, a hydrophobic section (damming section) 11, a reacting and detecting section (analyzing section) 13, a first substrate 15, a second substrate 16, an actuating electrode (electrode, first switching valve, electrowetting valve) 20, an actuating electrode (electrode, second switching valve, electrowetting valve) 21, a reference electrode 22 (electrode, first switching valve, electrowetting valve), a reference electrode 23 (electrode, second switching valve, electrowetting valve), electrode pads 30, and extraction electrodes 34.

The main flow channel 1 is a flow channel portion into and out of which a first liquid (solution) 40 is charged and discharged and into which a second liquid (solution) 41 is charged. Provided inside of the main flow channel 1 are the hydrophobic section 11 and the reacting and detecting section 13 (analyzing section). Further, the main flow channel 1 has one end (on the right as one faces the drawing) connected to the open hole 7.

It should be noted that the other end (on the left as one faces the drawing) of the main flow channel 1 may be closed as shown in (a) of FIG. 1 or, as shown in (f) of FIG. 1, may not be closed and may be connected to the first introduction flow channel 2 or the like.

The hydrophobic section 11 has its outer wall surface (gas-solid interface or liquid-solid interface) made entirely or partially of a hydrophobic material and, because of its hydrophobicity, dams (stops) the first liquid 40, which has been introduced into the main flow channel 1, before the first liquid 40 reaches the open hole 7.

It should be noted that by rendering a partial region of the outer wall surface of the hydrophobic section 11 hydrophobic and another partial region hydrophilic, the degree of hydrophobicity of the hydrophobic section 11 can be adjusted.

Further, although the present embodiment employs a configuration in which the first liquid 40 is dammed by the hydrophobic section 11, the hydrophobic section 11 may not be provided. In this case, the first liquid 40 reaches the open hole 7 and then stops on forming, because of surface tension, a gas-liquid interface of any of the following shapes (i) to (iii), depending on the degree of hydrophobicity or hydrophilicity of flow channel inner surfaces (surface states of the first and second substrates 15 and 16) leading to the open hole 7: (i) a convex shape slightly projecting in dome form because of the surface tension of the solution (see (c) of FIG. 1); (ii) a substantially planar shape (see (d) of FIG. 1); and (iii) a concave shape whose central portion is slightly depressed in small-plate form (see (e) of FIG. 1).

It should be noted that (c) of FIG. 1 shows a case where the first substrate 15 and the second substrate 16 have hydrophobic surfaces (at a contact angle of larger than 90 degrees), that (d) of FIG. 1 shows a case where the surfaces are at a contact angle of 90 degrees, and that (e) of FIG. 1 shows a case where the first substrate 15 and the second substrate 16 have hydrophilic surfaces (at a contact angle of smaller than 90 degrees).

The reacting and detecting section 13 is a part that causes a reaction of the first liquid 40 introduced into the main flow channel 1 and/or detects ingredients of the first liquid 40, and is formed by electrodes for carrying out antigen-antibody reaction (analysis) and electrochemical detection (analysis). The present embodiment uses a configuration in which reaction and detection are carried out with the same electrodes, but is not to be limited to such a configuration. The present embodiment may use a configuration in which a reacting section and a detecting section are provided separately from each other. Further, a plurality of reacting and detecting sections 13 may be provided for measurement of a plurality of substances.

The first introduction flow channel 2 has one end connected to the first liquid introduction hole 5, into which the first liquid 40 to be introduced into the structure (into the main flow channel 1) is poured, with the other end connected to an inner wall surface (flow channel inner surface) of the main flow channel 1.

It should be noted that the microanalysis chip 100 shown in (a) of FIG. 1 has its first introduction flow channel 2 connected to an inner wall surface (flow channel inner surface on the upper side of the drawing) of the main flow channel 1, but is not limited to such a structure. For example, as shown in (f) of FIG. 1, the first introduction flow channel 2 may be connected to the other end of the main flow channel 1.

The first discharge flow channel 3 has one end connected to the first liquid-discharging section 8, which is open to the outside, with the other end connected to an inner wall surface of the main flow channel 1. Further, the first discharge flow channel 3 is provided with a first switching valve that regulates the flow of a liquid. In the present embodiment, the first switching valve is, but is not to be limited to, an electrowetting valve constituted by a combination of the actuating electrode 20 and the reference electrode 22. The electrowetting valve may be replaced by a diaphragm valve or the like which can stop or start the inflow of a solution (or which can regulate the flow of a solution). Hereinafter, a similar description is omitted as needed.

The second introduction flow channel 4 has one end connected to the second liquid introduction hole 6, into which a second liquid (solution) 41 to be introduced into the structure is poured, with the other end connected to an inner wall surface of the main flow channel 1. Further, the second introduction flow channel 4 is provided with a second switching valve that regulates the flow of a liquid. The second switching valve is an electrowetting valve constituted by a combination of the actuating electrode 21 and the reference electrode 23.

As shown in (b) of FIG. 1, the open hole 7 is a hole open to a side above the second substrate 16 (to the upper side of the drawing), and is a hole connected to the one end of the main flow channel 1 so as to connect (lead from) the inside to the outside of the main flow channel 1. Entrance and exit of air through the open hole 7 makes it possible to smoothly carry out introduction and charging of a solution.

Next, the first introduction flow channel 2 and the first discharge flow channel 3 are both provided at a side of the main flow channel 1 that is opposite to the open hole 7 with respect to the reacting and detecting section 13.

Further, as shown in (a) and (b) of FIG. 1, the microanalysis chip 100 is formed by the first substrate 15 (also see (a) of FIG. 2) and the second substrate 16 (also see (b) of FIG. 2). The first substrate 15 has formed therein grooves (such as a main flow channel forming groove by which the main flow channel 1 is constituted, a first introduction flow channel forming groove by which the first introduction flow channel 2 is constituted, and a first discharge flow channel forming groove by which the first discharge flow channel 3 is constituted) for use as parts of the flow channels, and the flow channels (main flow channel 1, first introduction flow channel 2, first discharge flow channel 3) are constituted by the second substrate 16 sealing the grooves formed in the first substrate 15.

It should be noted that (b) of FIG. 1 shows a region R1 that is a range into which a portion of the first liquid that has passed through the reacting and detecting section 13 during charging of the first liquid 40 is charged. Since the amount of a liquid in the region R1 does not vary from one analytical experiment to another, the amount of the first liquid 40 that passes through the reacting and detection section 13 during the charging can be said to be constant each time. Further, the amount in a second region R2 of the second liquid 41 that is introduced through the second introduction flow channel 4 does no vary from one analytical experiment to another, the amount of the second liquid 40 that passes through the reacting and detection section 13 during the charging can be said to be constant each time. It should be noted that the region R1 is a range that extends from the left-side edge portion of the reacting and detecting section 13 to the left edge of the hydrophobic section 11 (or, strictly, the gas-liquid interface of the solution dammed by the hydrophobic section 11). Meanwhile, the region R2 is a range that extends from the right side of the reacting and detecting section 13 (from the other end of the main flow channel 1) to the one end.

FIG. 2 is a set of structural drawings (a) and (b) respectively showing structures of substrates constituting the microanalysis chip 100 according to the present embodiment, (a) showing a structure of the first substrate 15 of the microanalysis chip 100, (b) showing a structure of the second substrate 16 of the microanalysis chip 100.

As shown in (a) of FIG. 2, the first substrate 15 has formed therein (i) depressed grooves (main flow channel forming groove, first introduction flow channel forming groove, first discharge flow channel forming groove) for use as parts of the main flow channel 1, the first introduction flow channel 2, the second introduction flow channel 4, and the first discharge flow channel 3 and (ii) through-holes for use as the first liquid-discharging section 8, as the open hole 7, as the first liquid introduction hole 5, and as the second liquid introduction hole 6.

Further, as shown in (b) of FIG. 2, the second substrate 16 is a substrate that is placed on the lower side of the substrate 15 shown in (a) of FIG. 2 so as to seal the grooves and through-holes formed in the first substrate 15. The second substrate 16 is provided with the reacting and detecting section 13, the actuating electrode 20, the actuating electrode 21, the reference electrode 22, the reference electrode 23, the electrode pads 30, the extraction electrodes 34, and the hydrophobic section 11. Further, the absorber 9 is placed in the first liquid-discharging section 8. The configurations of the first and second substrates 15 and 16 will be described in detail later.

The first liquid-discharging section 8, provided at the discharging side of the first discharge flow channel 3, is made open to the atmosphere by a through-hole formed in the first substrate 15, with the absorber 9 provided on the second substrate 16.

The absorber 9 is an absorber that absorbs a liquid (solution), and may be a polymer absorber or any absorber that is made of a material such as a porous substance, a hydrophilic mesh, a spongy body, cotton, filter paper, or any other material that absorbs a liquid by capillary force.

The absorber 9 makes it possible to discharge a solution in a short period of time, thus achieving a reduction in measurement time. Further, the retention of a liquid by the absorber 9 brings about an advantage of making it possible to prevent the solution from flowing out to the outside.

Through the electrode pads 31 and the extraction electrodes 34, electrical control signals are inputted and detection signals are outputted. Use of gold as the material for the electrode pads 31 and the extraction electrodes 34 allows concomitant use of a step of making other electrodes with gold, thus achieving a simplification of the process. The electrode pads 31 and the extraction electrodes 34 may be otherwise made of a conducting material containing a material such as platinum, aluminum, or copper.

(Configurations of the First and Second Substrates 15 and 16)

The first substrate 15 has a thickness of approximately 0.1 mm to 10 mm. Further, the second substrate 16 has a thickness of approximately 0.01 mm to 10 mm. The open hole 7 is a through-hole having a diameter of 10 μm or larger.

The microanalysis chip 100 can be constituted by joining the first substrate 15 and the second substrate 16 on top of each other. For example, the first substrate 15 can be constituted by a PDMS (polydimethylsiloxane) substrate having formed therein depressed grooves for use as parts of the flow channels, and the second substrate 16, which covers (seals) the first substrate 15, can be constituted by a glass substrate. The first substrate 15, made of PDMS, is hydrophobic (contact angle of 100 degrees to 120 degrees), and the second substrate 16, made of glass, is hydrophilic (contact angle of 5 degrees to 30 degrees). Therefore, each of the flow channels is formed by four inner wall surfaces (in the present embodiment, e.g., four inner wall surfaces forming a rectangular cross-section of the main flow channel 1) one of which is made of glass and therefore is hydrophilic (glass) and the other three of which are hydrophobic (PDMS).

In this structure, as the groove width becomes narrower, the proportion of the hydrophilic wall surface (glass) in the whole of the four inner wall surfaces constituting the flow channel becomes relatively smaller and the proportion of the hydrophobic wall surfaces (PDMS) becomes relatively larger, so that there is an overall reduction in capillary force. On the other hand, the capillary force becomes larger as the flow channel width (groove width) becomes wider. By employing this principle, the capillary force that acts on each flow channel can be adjusted.

The first substrate 15 and the second substrate 16 are not limited to these materials, and as long as each of the flow channels has inner wall surfaces at least part of which is made of a material that is hydrophilic, it is possible to select an appropriate material according to a use of the microanalysis chip 100. For example, in the case of incorporation into the microanalysis chip 100 of a detecting section that carries out optical detection, it is desirable that either or both of the first and second substrates 15 and 16 be made of a transparent or semi-transparent material that emits little light in response to exciting light.

Examples of such a transparent or semi-transparent material include glass, quartz, a thermosetting resin, a thermoplastic resin, a film, etc. Among them, silicon resin, acrylic resin, and styrene resin are preferred in view of transparency and moldability. Examples of a plastic material that emits little light in response to exciting light include a fluorine plastic material such as fluorinated polymethyl methacrylate obtained by replacing a hydrogen atom of polymethyl methacrylate with a fluorine atom, polymethyl methacrylate obtained by using, as additives such as a catalyst and a stabilizer, members that do not produce fluorescence, etc.

On the other hand, in the case of electric control and electric determination in a flow channel of the microanalysis chip 100, it is necessary to form electrodes on the surface of the first or second substrate 15 or 16. Therefore, either or both of the first and second substrates 15 and 16 is/are made of a material capable of electrode formation. Preferred examples of a material capable of electrode formation include glass, quartz, and silicon in view of flatness and workability. Further, for easy manufacture, it is preferable that the electrodes be formed on the second substrate 16, in which no grooves are formed.

The “hydrophilicity” and “hydrophobicity” of the inner wall surfaces of each flow channel can be easily achieved by using a substrate made of a hydrophilic material and a substrate made of a hydrophobic material. However, the hydrophilicity and the hydrophobicity as used in the present invention are not limited to those derived from the properties of such materials. For example, the “hydrophilicity of part of the inner wall surfaces of a flow channel” can be achieved by carrying out a hydrophilic treatment on a hydrophobic part of the flow channel. Conversely, the “hydrophilicity of part of the inner wall surfaces of a flow channel” can be achieved by carrying out a hydrophobic treatment such as formation of a hydrophobic film on part of a surface of a substrate made of a hydrophilic material.

Usable examples of such a hydrophilic treatment include oxygen plasma treatment, UV (ultraviolet) treatment, etc. Alternatively, the hydrophilicity can also be enhanced by applying, onto the surface, a surface-active agent or a reagent having a hydrophilic functional group. On the other hand, examples of such a hydrophobic treatment include hydrofluoric acid treatment, a method for forming tetrafluoroethylene coating, etc.

(Method for Forming the Flow Channels)

Possible examples of a method for forming the flow channels include a method based on machining, a method based on laser processing, a method based on etching with a chemical or a gas, an injection molding process that involves the use of a mold, a press molding method, a method based on casting, etc. Among these methods, the method that involves the use of a mold and the method based on etching are preferred in terms of high reproducibility of shape dimensions.

The shape of a cross-section of each flow channel orthogonal to the direction that a solution flows (flow direction) is not limited to a rectangle, but may be a circle, an ellipse, a semicircle, an inverted triangle, or the like.

(Dimensions of the Flow Channels)

The widths (groove widths) and heights (groove depths) of the main flow channel 1, of the first introduction flow channel 2, of the second introduction flow channel 4, and of the first discharge flow channel 3 are set as such dimensions that a solution can permeate into each of the flow channels by solution wettability and capillary force.

It is preferable that the heights be set to be approximately 1 μm to 5 mm. For example, the heights are all substantially the same (approximately 50 μm). Although the heights do not always have to be the same, the same heights would allow easy manufacture and make it possible to adjust capillary force only by adjusting the widths.

It should be noted that since capillary force is unnecessary in the case of a solution that is transferred by using an external pump, part of the inner wall surfaces of each flow channel does not need to be hydrophilic. In this case, therefore, the first discharge flow channel 3 does not need to be provided with the first switching valve.

It is preferable that the widths be set to be approximately 1 μm to 5 mm. In this case, it is desirable that the heights be the same.

It should be noted here that the average groove width is the average of groove widths of the whole of each flow channel along a direction perpendicular to the direction that a liquid flows through that flow channel.

It should be noted here that it is preferable that assuming that W1 is the average groove width of the main flow channel 1 and W2 is the average groove width of the first introduction flow channel 2, W2<W1 be satisfied. Such a configuration makes it possible to, after discharging a solution remaining in the first liquid introduction hole 5, easily and completely discharge the solution out of the main flow channel 1.

It should be noted that each of the flow channels does not need to be constant in width. For example, the main flow channel 1 may be structured to be wide in width only in the part where the reacting and detecting section 13 is provided. Widening the width makes it possible to enlarge the area of the reacting and detecting section 13.

Further, each of the flow channels does not need to be constant in height. In this case, too, optimally designing both the height and the width makes it possible to, after discharging the solution remaining in the first liquid introduction hole 5, completely discharge the solution out of the main flow channel 1.

Further, the hydrophobic section 11 provided in the place where the main flow channel 1 is connected to the open hole 7. The hydrophobic section 11 is a part where the contact angle between a solution and the first substrate 15 (or the second substrate 16) is 90 degrees or larger, and can be formed, for example, by providing a hydrophobic material such as a fluorinated hydrophobic agent or a negative resist on part of the first substrate 16.

The provision of the hydrophobic section 11 in the place where the main flow channel 1 is connected to the open hole 7 causes no capillary force to act on the place, thus preventing a solution from flowing into the open hole 7. This allows the open hole 7 to surely fulfill its functions and makes it possible to stably carry out an operation of introducing a solution.

It should be noted that the hydrophobic section 11 may be constituted by an electrowetting valve capable of regulating the flow of a liquid when a voltage is applied. Such a configuration makes it possible to select whether to dam the solution at the hydrophobic section 11, i.e., whether to charge the liquid up to the hydrophobic section 11 or up to the open hole 7. This makes it possible to carry out a quantitative analysis by selecting an amount of a liquid for analytical use from among two amounts of liquid as needed. It should be noted that such an electrowetting valve will be described in detail later.

(Electrowetting Valve)

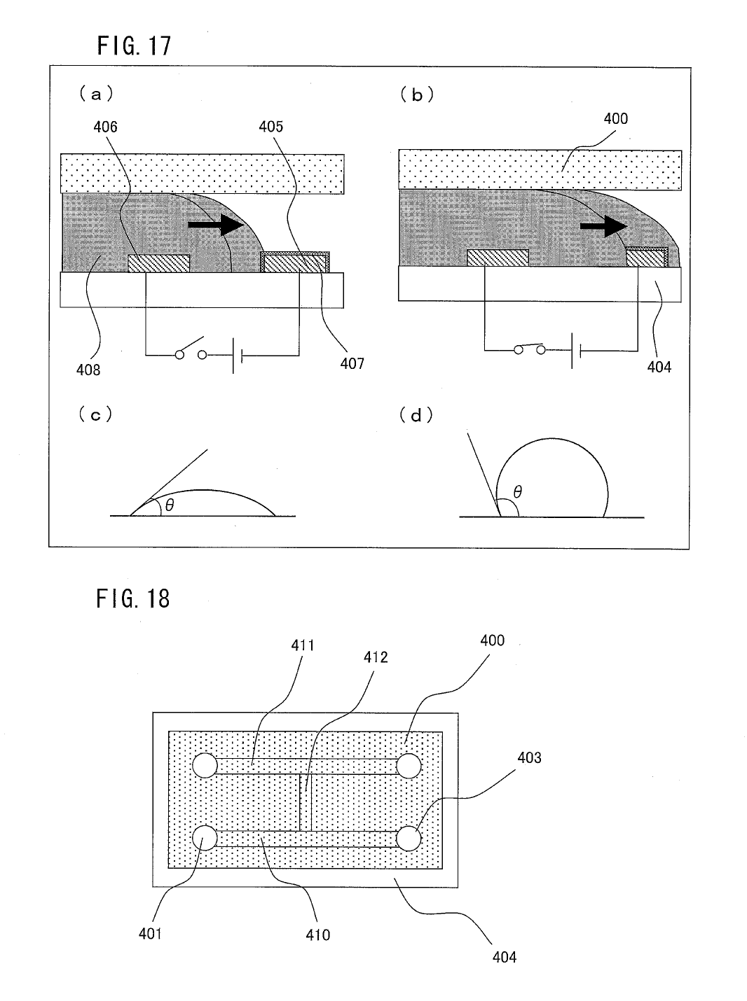

Next, an electrowetting method is described with reference to FIGS. 16 and 17. As a simple method for transferring a solution (opening and closing the flow of a solution), there are a microvalve based on the electrowetting method, as proposed in Patent Literature 1. FIG. 16 is a schematic view showing an example of a microanalysis chip based on an electrowetting valve.

As shown in FIG. 16, the microanalysis chip has provided in its flow channel 402 an electrowetting valve including an actuating electrode 405 and a reference valve 406. A surface of the actuating electrode 405 is hydrophobic when no voltage is applied, and is hydrophilic when a voltage is applied. This makes it possible to switch between the stoppage and movement of a liquid (open and close the flow of a liquid) according to voltage application.

Next, FIG. 17 is a set of schematic views (a) and (b) for explaining the operation of the electrowetting valve, (a) showing a state of the electrowetting valve in a case where no voltage is applied between the actuating electrode 405 and the reference electrode 406, (b) showing a state of the electrowetting valve in a case where a voltage has been applied between the actuating electrode 405 and the reference electrode 406.

When no voltage is applied, a hydrophobic film 407 is formed on the surface of the actuating electrode 405. Therefore, a solution 408 having flowed through the flow channel by capillary force stops at a point in time where it reaches the actuating electrode 405. Application of a voltage renders the surface of the actuating electrode 405 hydrophilic because of the electrowetting effect, so that the solution 408, which has been at rest, passes over the actuating electrode 405 to flow through the flow channel.

The first discharge flow channel 3 and the second introduction flow channel 4 of the microanalysis chip 100 are provided with electrowetting valves (the first switching valve and the second switching valve, respectively) each having at least a reference electrode and an actuating electrode, and each of these electrowetting valves serves as a switching valve that regulates the flow of a solution.

The first discharge flow channel 3 and the second introduction flow channel 4 are provided with the actuating electrodes 20 and 21 for use as parts of the electrowetting valves, respectively. In the vicinity of the first discharge flow channel 3 at the one end of the main flow channel 1 and in the second liquid introduction hole 6, the reference electrodes 22 and 23 for use as parts of the electrowetting valves are provided, respectively.

The actuating electrodes 20 and 21 and the reference electrodes 22 and 23 are wired to electrode pads 30 via extraction electrodes 34. Voltage application is controlled by an external device (not illustrated) connected to the electrode pads 30, so that an operation of opening and closing the switching valves is carried out.

A surface of the actuating electrode of each of the electrowetting valves is hydrophobic when no voltage is applied, and is hydrophilic when a voltage is applied. This makes it possible to switch between the stoppage and movement of a liquid (open and close the flow of a liquid) according to voltage application.

As shown in FIG. 17, when no voltage is applied, the surface of the actuating electrode 405 is hydrophobic. Therefore, the solution 408, which has flowed t hrough the flow channel by capillary force, stops at a point in time where it reaches the actuating electrode 405 ((a) of FIG. 17). Application of a voltage renders the surface of the actuating electrode 405 hydrophilic because of the electrowetting effect, so that the solution 408, which has been at rest, passes over the actuating electrode 405 to flow through the flow channel ((b) of FIG. 17).

For the purpose of surely stopping the solution 408, it is preferable that a portion of the flow channel above the actuating electrode 405 be hydrophobic when no voltage is applied. For that purpose, it is preferable that the first substrate 15 per se be made of a hydrophobic material. The surface of the first substrate 15 may be rendered partly or wholly hydrophobic, for example, by forming a hydrophobic film partly or wholly on the surface of the first substrate 15.

Further, although the present embodiment uses electrowetting valves as microvalves, this does not imply any limitation. Instead, it is possible to use anything, such as diaphragm valves, which can stop or start the inflow of a liquid (or which can regulate the flow of a solution).

(c) of FIG. 17 shows the appearance of a droplet of water in the case of a small contact angle, and (d) of FIG. 17 shows the appearance of a droplet of water in the case of a large contact angle. Each of the contact angles θ shown in (c) and (d) of FIG. 17 is an angle formed by a line tangential to the droplet surface and the material surface at a point of contact between the material and the droplet surface, and is called a contact angle. In a case where the liquid and the material have a high affinity for each other, the contact angle θ is small as shown in (c) of FIG. 17. In a case where the liquid and the material have a low affinity for each other, the contact angle θ is large as shown in (d) of FIG. 17. A capillary phenomenon occurs when the contact angle θ is small, i.e., between a liquid and a material that have a high affinity for each other.

(Configurations of the Actuating Electrodes 20 and 21)

The actuating electrodes 20 and 21 are formed by gold thin films (conducting thin films). Carbon or bismuth may be used instead of gold. These materials have an advantage of less generating hydrogen or the like when a voltage is applied to the actuating electrodes 20 and 21 and therefore causing less deterioration in the electrodes.

Each of the actuating electrodes 20 and 21 may be configured to have provided on a surface thereof a thin film having a contact angle of 80 degrees or larger with respect to pure water at 25° C. (normal temperature) and a specific resistance of 18 kΩ·cm. Employing such a configuration allows a solution to surely stop when no voltage is applied, thus making it possible to stably operate the switching valve.

The thin film is suitably made of a fluorine-containing substance or a substance having a thiol group. Using such a hydrophobic substance as the material for the thin film allows the thin film to have a contact angle of larger than 90 degrees on the actuating electrode 20 or 21 in the absence of an applied voltage, thus making it easy to stop a liquid at the switching valve. This makes it possible to more stably carry out the operation of opening and closing the switching valve. It should be noted that the thin film is not to be limited to such a substance, and needs only have a larger contact angle on the surface than a gold thin film, i.e., exhibit a stronger hydrophobicity than a gold thin film.

Further, it is preferable that the thin film on the surface of each of the actuation electrodes 20 and 21 have a thickness of 0.1 nm or larger to 100 nm or smaller.

It should be noted that in view of a monoatomic film or monomolecular film, a lower limit on the thickness of the thin film is approximately 1 Å, i.e., approximately 0.1 nm.

This configuration makes it possible to render the surface of each of the actuation electrodes 20 and 21 hydrophilic with a smaller voltage, thus achieving a reduction in voltage necessary for the operation of opening and closing the switching valve. This makes it possible to downsize the device that applies a voltage and, furthermore, downsize the system.

Further, a dielectric film may be provided between the conducting thin film and the thin film. This improves the stability of the operation of opening and closing the switching valve, but requires a higher applied voltage for the operation of opening and closing the switching valve.

Further, each of the actuating electrodes may be constituted by forming a conducting thin film alone. Exposure of a metal surface to natural air causes a thin film (contact angle of 60 degrees to 85 degrees) composed of carbon deposits to be formed on the surface. This thin film has a contact angle of smaller than 90 degrees with respect to the above-mentioned pure water, but has a contact angle of 60 degrees to 85 degrees to be low in degree of hydrophilicity and is as extremely thin as 0.1 nm or lager to 1 nm or smaller.

Such an actuating electrode functions sufficiently as an actuating electrode for an electrowetting valve. Further, as compared with the case of formation of such a thin film as that mentioned above, there is an advantage of achieving a reduction i n applied voltage necessary for the operation of opening and closing the switching valve.

It is preferable that each of the flow channels be narrow in groove width in the part where the actuating electrode is provided. This configuration makes it easy to stop a liquid on the actuating electrode when no voltage is applied, thus making it possible to more stably carry out the valve operation.

(Configurations of the Reference Electrodes 22 and 23)

The reference electrodes 22 and 23 for use as parts of the electrowetting valves are made of silver/silver chloride. The reference electrodes 22 and 23, made of silver/silver chloride, bring about such an advantage that there is little change in potential when a current is passed through the electrodes. The reference electrodes 22 and 23 may be made of gold, carbon, or bismuth instead of being made of silver/silver chloride.

Voltages to be applied between the actuating electrode 20 and the reference electrode 22 and between the actuating electrode 21 and the reference electrode 23 vary depending on the configurations of the actuating electrodes 20 and 21, but are preferably 3 V or lower. In particular, in a case where each of the actuating electrodes 20 and 21 is constituted by a gold thin film and a thin film formed by exposing a surface of the gold thin film to air, operation is possible with an applied voltage of 1 V or lower. A reduction in applied voltage makes it possible to downsize the system so that the system can be applied to a portable device.

(Explanation of Operation)

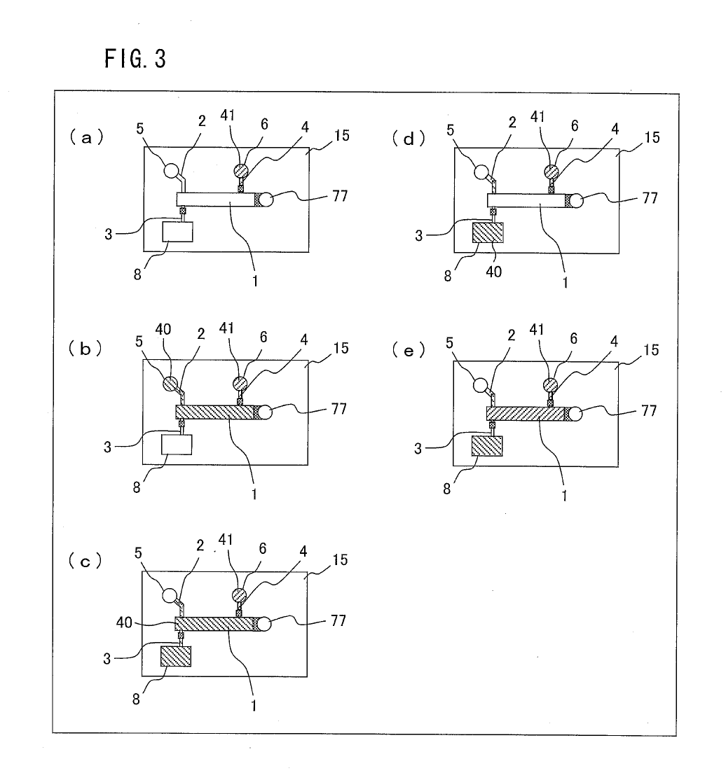

FIG. 3 shows the flow of solutions in the microanalysis chip 100. The flow of solutions in the microanalysis chip 100 is described here with reference (a) through (e) of FIG. 3.

The second liquid 41 is poured into the second liquid introduction hole 6 first ((a) of FIG. 3), and then the first liquid 40 is poured into the first liquid introduction hole 5. The amount of each solution thus poured needs only be larger than the capacity of the main flow channel 1, and does not need to be constant.

The first liquid 40, introduced through the first liquid introduction hole 5, is flows through the first introduction flow channel 2 into the main flow channel 1 toward the open hole 7 by capillary force, and stops after being charged into the main flow channel 1 ((b) of FIG. 3).

Next, by opening the first switching valve provided in the first discharge flow channel 3, the first liquid 40 remaining in the first liquid introduction hole 5 is discharged into the first liquid-discharging section 8 through the first discharge flow channel 3 by capillary force ((c) of FIG. 3). It should be noted here that the first introduction flow channel 2 and the first discharge flow channel 3 are connected to the main flow channel 1 at a side of the main flow channel 1 that is opposite to the open hole 7 with respect to the reacting and detecting section 13. Therefore, the first liquid 40 remaining in the first liquid introduction hole 5 is discharged through the first discharge flow channel 3 without passing through the reacting and detecting section 13. Therefore, regardless of the amount of the first liquid 40 poured, the amount of the first liquid 40 that passes through the reacting and detecting section 13 provided in the main flow channel 1 is constant each time. This makes it possible to carry out quantitative reaction and/or detection.

Then, the first liquid 40 charged into the main flow channel 1 is discharged into the first liquid-discharging section 8 through the first discharge flow channel 3 ((d) of FIG. 3). Since the first discharge flow channel 3 is connected to the main flow channel 1 at a side of the main flow channel 1 that is opposite to the open hole 7 with respect to the reacting and detection section 13, the first liquid 40 can be discharged without remaining in the main flow channel 1.

Further, the structure may include the absorber 9 in the first liquid-discharging section 8. This configuration makes the discharge rate higher than in the case of discharge of the solution only by capillary force in the flow channel, thus making it possible to easily and completely discharge the solution out of the main flow channel 1.

Further, the introduction of air through the open hole 7 is facilitated by setting the minimum value of groove widths of the main flow channel 1 larger than the minimum values of groove widths of the first introduction flow channel 2 and the first discharge flow channel 3. This makes it possible to easily and completely discharge the solution out of the main flow channel 1.

Furthermore, the entrance of the solution into the open hole 7 can be prevented by constructing the structure such that the hydrophobic section 11 whose outer wall surfaces are wholly or partially hydrophobic is provided in the place where the main flow channel 1 is connected to the open hole 7. This allows more stable liquid transfer.

Next, opening the second switching valve provided in the second introduction flow channel 4 causes the second liquid 41 introduced through the second liquid introduction hole 6 to flow through the second introduction flow channel 4 into the main flow channel 1 by capillary force, and stops after being charged into the main flow channel 1 ((e) of FIG. 3). In so doing, regardless of the amount of the second liquid 41 poured, the amount of the second liquid 41 that passes through the reacting and detecting section 13 provided in the main flow channel 1 is constant each time. This makes it possible to carry out quantitative reaction and/or detection on two (two types of) solutions without using an external pump or the like.

It should be noted that the first introduction flow channel 2 may be provided with a switching valve. In this case, the entrance of the second liquid 41 into the first liquid introduction hole 5 is prevented, so that there is a further improvement in quantitivity of the amount of the second liquid 41 that passes through the reacting and detecting section 13 provided in the main flow channel 1.

Further, the first introduction flow channel 2 may be provided with a backflow preventing section. Usable examples of the backflow preventing section include a groove structure based on meniscus, a structure provided with a check valve, etc. In this case, the entrance of the second liquid 41 into the first liquid introduction hole 5 is prevented, so that there is a further improvement in quantitivity of the amount of the second liquid 41 that passes through the reacting and detecting section 13 provided in the main flow channel 1.

(Immunoassay)

The microanalysis chip 100 shown in FIG. 1 makes it possible to carry out liquid transfer control and quantitative reaction and/or detection on a plurality of solutions without using an external pump or the like.

For example, the microanalysis chip 100 shown in FIG. 1 can be utilized for the measurement of antigen concentrations by such an immunoassay as follows: An antigen-antibody reaction is produced first by immobilizing an antibody or the like in an inner part of the main flow channel 1 and pouring a mixture of a liquid containing an antigen and a liquid containing an enzyme-labeled antibody; then, an enzyme substrate reaction is produced by further pouring a substrate solution, and the amount of the antigen is measured by using a detection electrode to detect the amount of an electrode active substance produced by the enzyme substrate reaction.

Measurement of a specific protein with use of the microanalysis chip 100 can be performed through the following procedures:

(1) Immobilize an antibody on a detection electrode.

(2) Introduce the first liquid 40 into the main flow channel 1. Use, as the first liquid 40, a mixture of a pretreated (separated, diluted, decomposed) blood sample and an enzyme-labeled antibody. Discharge the first liquid 40 after stopping it for a certain period of time.

(3) Introduce a substrate solution as the second liquid 41 and stop it for a certain period of time.

(4) Measure the amount of the specific protein in the blood sample by electrochemical detection.

This configuration makes it possible to carry out quantitative reaction and detection of small amounts of solutions, and makes it possible to easily and accurately carry out the measurement of a specific protein by immunoassay. Use of the microanalysis chip 100 of the present embodiment brings about an advantage of making it possible to downsize the system and reduce the cost and making it easy to apply the system to a portable device.

Although the present embodiment has shown a case where electrochemical detection is carried out, detection may be carried out by another method such as optical detection. For example, an antigen-antibody reaction is produced first by immobilizing an antibody or the like in an inner part of the main flow channel 1 and introducing a mixture of a liquid containing an antigen and a liquid containing a fluorescent-pigmented antibody. By then discharging the solution and irradiating the solution with exciting light, the amount of the antigen can be measured by the amount of fluorescence. In this case, there is no need to provide the second introduction flow channel 4 or the second switching valve.

### Embodiment 2

### Configuration of a Microanalysis Chip 101

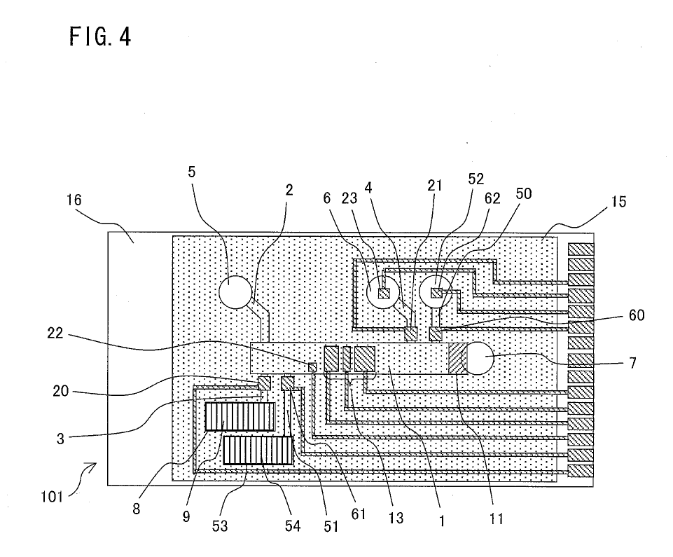

Next, a microanalysis chip 101 that differ in structure from Embodiment 1 is described in detail with reference to FIG. 4.

FIG. 4 is a plan view showing a structure of a microanalysis chip 101 according to the present embodiment. The microanalysis chip 101 is identical to Embodiment 1, except that it includes a third introduction flow channel 50 and a second discharge flow channel 51. Therefore, the structure is described in detail only as to the third introduction flow channel 50 and the second discharge flow channel 51, and a description of any other component is omitted.

The third introduction flow channel 50 has one end connected to a third liquid introduction hole 52 into which a third liquid 40 to be introduced into the structure is poured, with the other end connected to an inner wall surface of the main flow channel 1. Further, the third introduction flow channel 50 is provided with a third switching valve that regulates the flow of a liquid.

The second discharge flow channel 51 has one end connected to a second liquid-discharging section 5 that is open to the outside, with the other end connected to an inner wall surface (flow channel inner wall surface) of the main flow channel 1. Further, the second discharge flow channel 51 is provided with a fourth switching valve that regulates the flow of a liquid. Moreover, the second discharge flow channel 51 is connected to the main flow channel 1 at a side of the main flow channel 1 that is opposite to the open hole 7 and the third introduction flow channel 5 with respect to the reacting and detecting section 13.

Further, the third introduction flow channel 50 and the second discharge flow channel 51 each have inner wall surfaces (flow channel inner surfaces) at least part of which is hydrophilic.

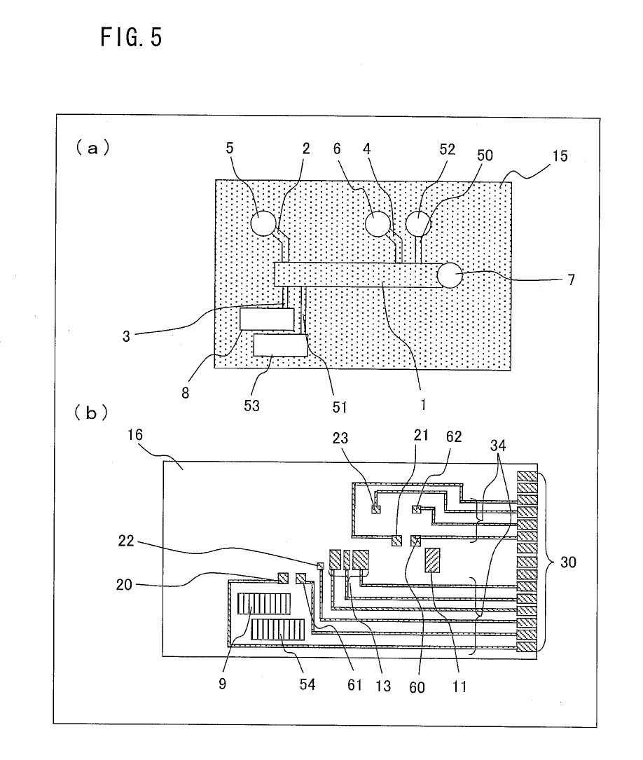

FIG. 5 is a set of structural drawings (a) and (b) respectively showing structures of substrates constituting the microanalysis chip 101 according to the present embodiment, (a) showing a structure of a first substrate 15, (b) showing a structure of a second substrate 16.

As shown in (a) of FIG. 5, the first substrate 15 has formed therein (i) grooves for use as parts of the main flow channel 1, the first introduction flow channel 2, the second introduction flow channel 4, the third introduction flow channel 50, the first discharge flow channel 3, and the second discharge flow channel 51 and (ii) through-holes for use as the first liquid-discharging section 8, as the second liquid-discharging section 53, as the open hole 7, as the first liquid introduction hole 5, as the second liquid introduction hole 6, and as the third liquid introduction hole 52.

Further, as shown in (b) of FIG. 5, the second substrate 16 is provided with the reacting and detecting section 13, the actuating electrode 20 (electrode, first switching valve, electrowetting valve) for use as parts of an electrowetting valve, the actuating electrode 21 (electrode, second switching valve, electrowetting valve) for use as a part of an electrowetting valve, an actuating electrode 60 (electrode, third switching valve, electrowetting valve) for use as a part of an electrowetting valve, an actuating electrode 61 (electrode, fourth switching valve, electrowetting valve) for use as a part of an electrowetting valve, the reference electrode 22 (electrode, first switching valve, fourth switching valve, electrowetting valve) for use as a part of an electrowetting valve, the reference electrode 23 (electrode, second switching valve, electrowetting valve) for use as a part of an electrowetting valve, a reference electrode 62 (electrode, third switching valve, electrowetting valve) for use as a part of an electrowetting valve, the electrode pads 30, the extraction electrodes 34, and the hydrophobic section 11. Further, the absorber 9 and an absorber 54 are placed in the respective liquid-discharging sections.

The widths (groove widths) and heights (groove depths) of the third introduction flow channel 50 and the second discharge flow channel 51 are set as such dimensions that a solution can permeate into each of the flow channels by solution wettability and capillary force.

It is preferable that the heights be set to be approximately 1 μm to 5 mm. For example, the heights are all substantially the same (approximately 50 μm). Although the heights do not always have to be the same, the same heights would allow easy manufacture and make it possible to adjust capillary force only by adjusting the widths.

Since capillary force is utilized, it is preferable that the widths be set to be approximately 1 μm to 5 mm.

In the second liquid-discharging section 53, the first substrate 15 is open to the atmosphere, with the absorber 54 provided in the second substrate 16.

This configuration makes it possible to discharge a solution in a short period of time, thus achieving a reduction in measurement time. Further, the retention of a solution by the absorber 54 brings about an advantage of making it possible to prevent the solution from flowing out to the outside.

The third introduction flow channel 50 and the second discharge flow channel 51 are each provided with an electrowetting valve having at least a reference electrode and an actuation electrode and serving as as a switching valve that regulates the flow of a solution.

The third introduction flow channel 50 and the second discharge flow channel 51 are provided with the actuating electrodes 60 and 61 for use as parts of the electrowetting valves, respectively. In the vicinity of the second discharge flow channel 51 and in the third liquid introduction hole 52, the reference electrodes 22 and 62 for use as parts the electrowetting valves are provided, respectively.

The actuating electrodes and the reference electrodes are wired to electrode pads 30 via extraction electrodes 34. Voltage application is controlled by an external device (not illustrated) connected to the electrode pads 30, so that an operation of opening and closing the switching valves is carried out.

For the purpose of surely stopping the s olution, it is preferable that a portion of the flow channel above the actuating electrode be hydrophobic when no voltage is applied.

Further, although the present embodiment uses electrowetting valves as microvalves, this does not imply any limitation. Instead, it is possible to use anything, such as diaphragm valves, which can stop or start the inflow of a liquid.

The actuating electrodes are formed by gold thin films (conducting thin films). Carbon or bismuth may be used instead of gold.

Each of the actuating electrodes may be configured to have provided on a surface thereof a thin film having a contact angle of 80 degrees or larger with respect to pure water at 25° C. (normal temperature) and a specific resistance of 18 kΩ·cm. The thin film is suitably made of a fluorine-containing substance or a substance having a thiol group. The thin film is not to be limited to such a substance, and needs only have a larger contact angle on the surface than a gold thin film. Further, it is preferable that the thin film on the gold thin film have a thickness of 0.1 nm or larger to 100 nm or smaller.

Further, each of the actuating electrodes may be constituted by forming only a conducting thin film. It is preferable that each of the flow channels be narrow in groove width in the part where the actuating electrode is provided. The reference electrodes for use as parts of the electrowetting valves are made of silver/silver chloride.

A voltage to be applied between each of the actuating electrodes and its corresponding reference electrode varies depending on the configuration of the actuating electrode, but is preferably 3 V or lower. In particular, in a case where each of the actuating electrodes is constituted by a gold thin film and a thin film formed by exposing a surface of the gold thin film to air, operation is possible with an applied voltage of 1 V or lower.

(Explanation of Operation)

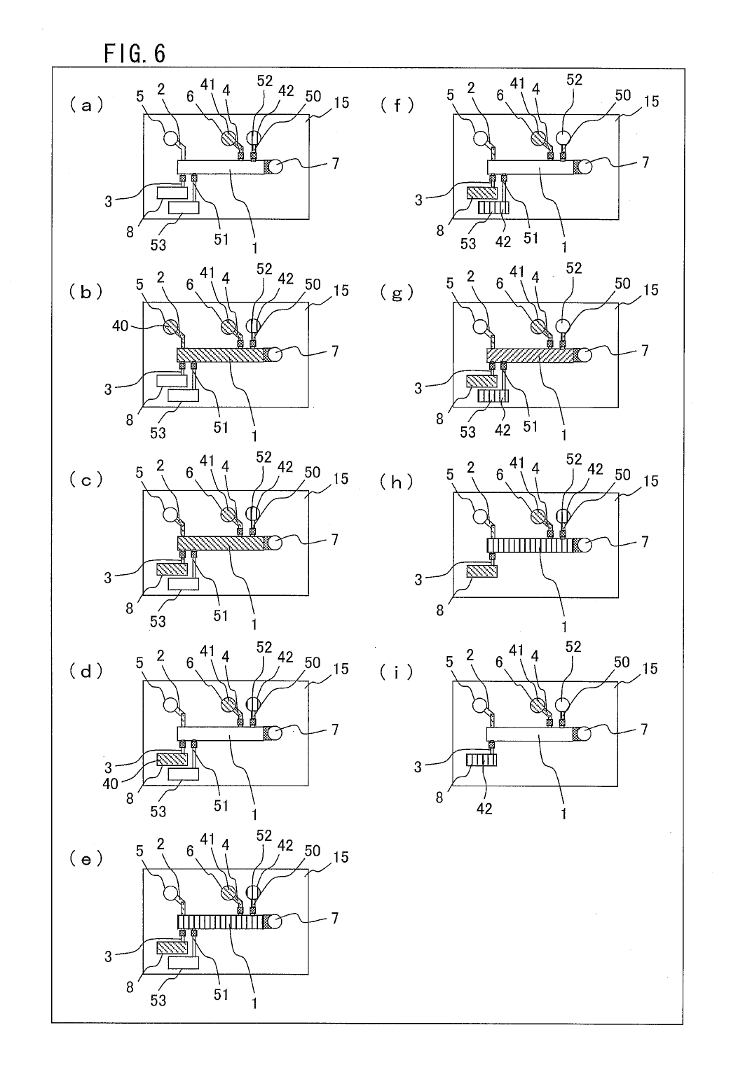

FIG. 6 shows the flow of solutions in the microanalysis chip 101. The flow of solutions in the microanalysis chip 100 is described here with reference (a) through (i) of FIG. 6.

The second liquid 41 and the third liquid 42 are poured into the second liquid introduction hole 6 and the third liquid introduction hole 52 first, respectively ((a) of FIG. 6), and then the first liquid 40 is poured i nto the first liquid introduction hole 5. The amount of each solution thus poured needs only be larger than the capacity of the main flow channel 1, and does not need to be constant.

The first liquid 40, introduced through the first liquid introduction hole 5, flows through the first introduction flow channel 2 into the main flow channel 1 toward the open hole 7 by capillary force. Then, the first liquid 40 stops after being charged into the main flow channel 1 ((b) of FIG. 6).

Next, by opening the first switching valve provided in the first discharge flow channel 3, the first liquid 40 remaining in the first liquid introduction hole 5 is discharged into the first liquid-discharging section 8 through the first discharge flow channel 3 by capillary force ((c) of FIG. 6). It should be noted here that the first introduction flow channel 2 and the first discharge flow channel 3 are connected to the main flow channel 1 at a side of the main flow channel 1 that is opposite to the open hole 7 with respect to the reacting and detecting section 13. Therefore, the first liquid 40 remaining in the first liquid introduction hole 5 is discharged through the first discharge flow channel 3 without passing through the reacting and detecting section 13. Therefore, regardless of the amount of the first liquid 40 poured, the amount of the first liquid 40 that passes through the reacting and detecting section 13 provided in the main flow channel 1 is constant each time. This makes it possible to carry out quantitative reaction and/or detection.

Then, the first liquid 40 charged into the main flow channel 1 is discharged into the first liquid-discharging section 8 through the first discharge flow channel 3 ((d) of FIG. 6). Since the first discharge flow channel 3 is connected to the main flow channel 1 at a side of the main flow channel 1 that is opposite to the open hole 7 with respect to the reacting and detection section 13, the first liquid 40 can be discharged without remaining in the main flow channel 1.

Further, the structure may include the absorber 9 in the first liquid-discharging section 8. This configuration makes the discharge rate higher than in the case of discharge of the solution only by capillary force in the flow channel, thus making it possible to easily and completely discharge the solution out of the main flow channel 1.

Further, the introduction of air through the open hole 7 is facilitated by setting the minimum value of groove widths of the main flow channel 1 larger than the minimum values of groove widths of the first introduction flow channel 2 and the first discharge flow channel 3. This makes it possible to easily and completely discharge the solution out of the main flow channel 1.

Furthermore, the entrance of the solution into the open hole 7 can be prevented by constructing the structure such that the hydrophobic section 11 whose outer wall surfaces are wholly or partially hydrophobic is provided in the place where the main flow channel 1 is connected to the open hole 7. This allows more stable liquid transfer.

Next, the third switching valve provided in the third introduction flow channel 50 is opened, so that the third liquid 42 introduced through the third liquid introduction hole 52 flows through the third introduction flow channel 50 into the main flow channel 1 by capillary force to be charged into the main flow channel 1 ((e) of FIG. 6).

Next, by opening the fourth switching valve provided in the second discharge flow channel 51, those portions of the third liquid 42 in the third liquid introduction hole 52, in the third introduction flow channel 50, and in the main flow channel 1 are sequentially discharged into the second liquid-discharging section 53 through the second discharge flow channel 51 ((f) of FIG. 6).

Since the second discharge flow channel 51 is connected to the main flow channel 1 at a side of the main flow channel 1 that is opposite to the third introduction flow channel 50 with respect to the reacting and detecting section 13, all of the third liquid 42 passes through the reacting and detecting section 13 provided in the main flow channel 1.

Since the second discharge flow channel 51 is connected to the main flow channel 1 at a side of the main flow channel 1 that is opposite to the open hole 7 with respect to the reacting and detecting section 13, the third liquid 42 can be discharged without remaining in the main flow channel 1.

Further, the structure which includes the absorber 54 in the second liquid-discharging section 53 makes the discharge r ate higher than in the case of discharge of the solution only by capillary force in the flow channel, thus making it possible to easily and completely discharge the solution out of the main flow channel 1.

Further, the minimum value of groove widths of the main flow channel 1 may be set larger than the minimum values of groove widths of the third introduction flow channel 50 and the second discharge flow channel 51. In this case, the introduction of air through the open hole 7 is facilitated. This makes it possible to easily and completely discharge the solution out of the main flow channel 1.

Next, the second switching valve provided in the second introduction flow channel 4 is opened, so that the second liquid 41 introduced through the second liquid introduction hole 6 flows through the second introduction flow channel 4 into the main flow channel 1, and stops after being charged into the main flow channel 1 ((g) of FIG. 6). In so doing, regardless of the amount of the second liquid 41 poured, the amount of the second liquid 41 that passes through the reacting and detecting section 13 provided in the main flow channel 1 is constant each time.

This makes it possible to, without using an external pump or the like, carry out quantitative reaction and/or detection on two solutions (the first liquid 40 and the second liquid 41) and allow all of the other one solution (third liquid 42) poured to pass through the reacting and detecting section 13.

The first introduction flow channel 2 may be provided with a switching valve or a backflow preventing section. In this case, the entrance of the second liquid 41 into the first liquid introduction hole 5 is prevented, so that there is a further improvement in quantitivity of the amount of the second liquid 41 that passes through the reacting and detecting section 13 provided in the main flow channel 1.

(Immunoassay)

The microanalysis chip 101 shown in FIG. 4 makes it possible to carry out liquid transfer control and quantitative reaction and/or detection on a plurality of solutions without using an external pump or the like.

For example, the microanalysis chip 101 shown in FIG. 4 can be utilized for the measurement of antigen concentrations by such an immunoassay as follows: An antigen-antibody reaction is produced by immobilizing an antibody or the like in an inner part of the main flow channel 1 and pouring a mixture of a liquid containing an antigen and a liquid containing an enzyme-labeled antibody, and a nonspecifically adsorbed antigen is washed by pouring a cleaning solution; furthermore, an enzyme substrate reaction is produced by pouring a substrate solution, and the amount of the antigen is measured by using a detection electrode to detect the amount of an electrode active substance produced by the enzyme substrate reaction.

Measurement of a specific protein with use of the microanalysis chip 101 can be performed through the following procedures:

(1) Immobilize an antibody on a detection electrode.

(2) Introduce the first liquid 40 into the main flow channel 1. Use, as the first liquid 40, a mixture of a pretreated (separated, diluted, decomposed) blood sample and an enzyme-labeled antibody. Discharge the first liquid 40 after stopping it for a certain period of time.

(3) Introduce a cleaning solution as the third liquid 42 and discharge it.

(4) Introduce a substrate solution as the second liquid 41 and stop it for a certain period of time.

(5) Measure the amount of the specific protein in the blood sample by electrochemical detection.

This configuration makes it possible to carry out quantitative reaction and detection of small amounts of solutions, and makes it possible to easily and accurately carry out the measurement of a specific protein by immunoassay. Use of the microanalysis chip 101 of the present embodiment brings about an advantage of making it possible to downsize the system and reduce the cost and making it easy to apply the system to a portable device.

Although the present embodiment has shown a case where electrochemical detection is carried out, optical detection may be carried out. For example, the microanalysis chip 101 shown in FIG. 4 can be utilized for such optical measurement as follows: an antigen-antibody reaction is produced by immobilizing an antibody or the like in an inner part of the main flow channel 1 and introducing and charging a solution containing an antigen through the first introduction flow channel 2, an antigen-antibody reaction is produced by pouring a solution containing a fluorescent-pigmented labeled antibody through the second introduction flow channel 4, and by irradiating the solution with exciting light, the amount of the antigen is measured by the amount of fluorescence.

In the present embodiment, there are provided separate liquid-discharging sections (first liquid-discharging section 8, second liquid-discharging section 53) into which the first liquid 40 and the second liquid 41 are discharged, respectively. However, as shown in (h) and (i) of FIG. 6, there may be provided only a single liquid-discharging section (first liquid-discharging section 8). It should be noted that the operation up to (h) of FIG. 6 is the same as the operation from (a) through (e) of FIG. 6. Further, in (i) of FIG. 6, the third liquid 42 is discharged out of the main flow channel 1 through the first discharge flow channel 3 by opening the first switching valve. Further, in a case where there are provided separate liquid-discharging sections into which the first liquid 40 and the third liquid 42 are discharged, respectively, the operation of discharge into each liquid-discharging section needs only be carried out once. This reduces the amount of discharge, thus making it possible to more stably discharge each solution. Meanwhile, in the case of a configuration in which the first liquid 40 and the third liquid 42 are discharged from a common liquid-discharging section, it is only necessary to provide a single discharge flow channel and a single liquid-discharging section. This makes it possible to simplify the device.

Further, although, in the present embodiment, the number of (types of) solutions to be introduced is 3, this does not imply any limitation. The number of (types of) solutions to be introduced may be 4 or more. In a case where it is necessary to carry out quantitative reaction and/or detection of the solutions introduced, it is only necessary to construct a structure in which an introduction flow channel and a discharge flow channel are connected to the main flow channel 1 at a side of the main flow channel 1 that is opposite to the open hole 7 with respect to the reacting and detecting section 13.

### Embodiment 3

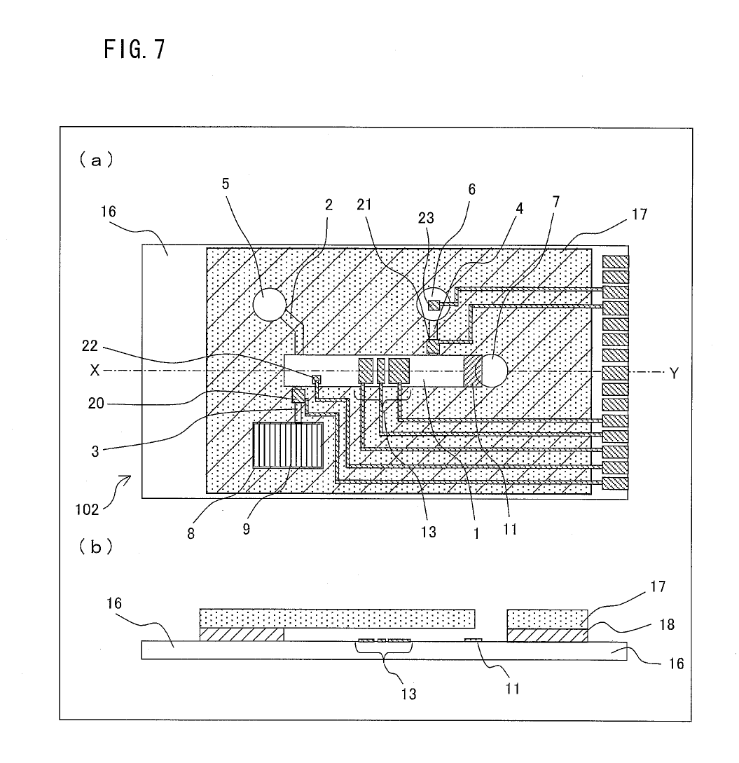

Next, a microanalysis chip 102 that differ in structure from Embodiments 1 and 2 is described in detail with reference to FIG. 7.

FIG. 7 is a set of diagrams (a) and (b) showing a structure of the microanalysis chip 102, (a) showing the structure of the microanalysis chip 102 as seen from a side of the microanalysis chip 102 through which a liquid is poured, (b) being a cross-sectional view of the structure of the microanalysis chip 102 as taken along the line X-Y.

The microanalysis chip 102 according to the present embodiment is different from Embodiments 1 and 2 in term of a configuration of substrates by which flow channels are formed, and is identical to Embodiment 1 in terms of the flow channel structure. For this reason, the configuration of substrates and a method for forming the flow channels are described in detail, and a description of any other component is omitted.

As shown in (a) of FIG. 7, the microanalysis chip 102 according to Embodiment 3 has a similar flow channel structure to the microanalysis chip 100 according to Embodiment 1.

Moreover, as shown in (b) of FIG. 7, the microanalysis chip 102 includes: an intermediate layer (flow channel forming layer) 18 having formed therein holes (groove side surfaces) for use as parts of the flow channels; and a second substrate (third substrate) 16 and a third substrate (fourth substrate) 17 provided on the upper and lower surfaces of the intermediate layer 18, respectively, so as to cover (seal) the holes (grooves) formed in the intermediate layer 18.

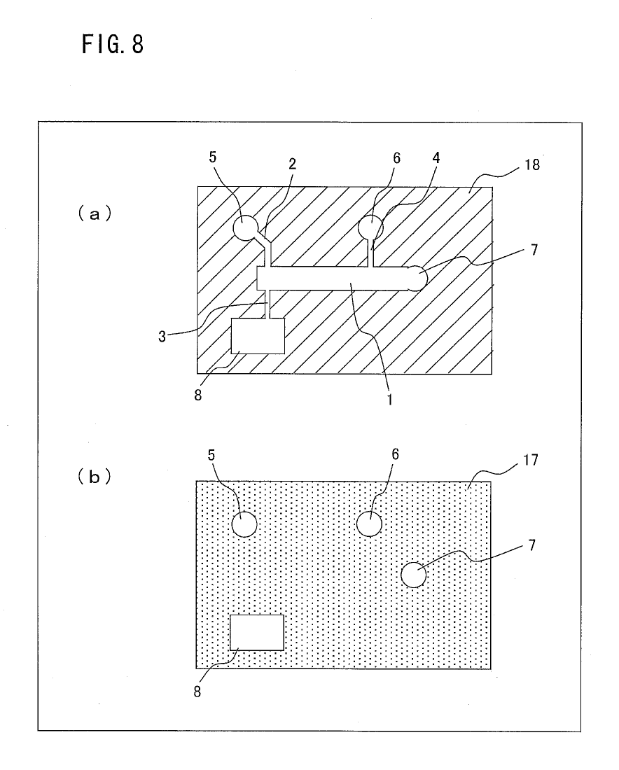

FIG. 8 is a set of structural drawings (a) and (b) showing a structure of the microanalysis chip 102 according to the present embodiment, (a) showing a structure of the intermediate layer 18 of the microanalysis chip 102, (b) showing a structure of the third substrate 17 of the microanalysis chip 102.

As shown in (a) of FIG. 8, the intermediate layer 18 has formed therein (i) holes (hole by which the main flow channel is formed, hole by which the first introduction flow channel 2 is formed, hole by which the first discharge flow channel 3 is formed) for use as parts of the main flow channel 1, the first introduction flow channel 2, the second introduction flow channel 4, and the first discharge flow channel 3 and (ii) through-holes for use as the first liquid-discharging section 8, as the open hole 7, as the first liquid introduction hole 5, and as the second liquid introduction hole 6.

As shown in (b) of FIG. 8, the third substrate 17 has formed therein through-holes for use as the first liquid-discharging section 8, as the open hole 7, as the first liquid introduction hole 5, and as the second liquid introduction hole 6, and is a substrate provided on the upper side of the intermediate layer 18 so as to seal the holes formed in the intermediate layer 18.

As shown in (b) of FIG. 2, the second substrate 16, structured in a similar way to Embodiment 1, is a substrate provided on the lower side of the intermediate layer 18 so as to seal the holes (grooves) and through-holes formed in the intermediate layer 18.

The third substrate 17 has a thickness of approximately 0.1 mm to 10 mm, and the second substrate 16 has a thickness of approximately 0.01 mm to 10 mm. The open hole 7 is a through-hole having a diameter of 10 μm or larger.

The thickness of the intermediate layer 18 corresponds to the hole height (hole depth) or the groove height (groove depth), and as such, is set to such a dimension that a solution can permeate into each of the flow channels by solution wettability and capillary force. Preferably, the thickness of the intermediate layer 18 is set to be approximately 1 μm to 5 mm. This makes the hole height constant and makes it possible to adjust capillary force only by adjusting the widths.

The microanalysis chip 102 can be constituted by joining on top of one another the third substrate 17, which is constituted by a PDMS (polydimethylsiloxane) substrate having through-holes formed herein, the intermediate layer 18, which is constituted by a hydrophobic film resist having through-holes formed therein, and the second substrate 16, which is constituted by a glass substrate that covers (seals) the intermediate layer 18. The third substrate 17, which is made of PDMS, and the intermediate layer 18, which is constituted by a film resist, are hydrophobic, and the second substrate 19, which is made of glass, is hydrophilic. Therefore, each of the flow channels has four inner wall surfaces one of which is made of glass and therefore is hydrophilic and the other three of which are hydrophobic.

In this structure, as the flow channel width (hole width) becomes narrower, the proportion of the hydrophilic inner wall surface in the whole of the four inner wall surfaces constituting the flow channel becomes relatively smaller and the proportion of the hydrophobic inner wall surfaces becomes relatively larger, so that there is an overall reduction in capillary force. On the other hand, the capillary force becomes larger as the flow channel width (hole width) becomes wider. By employing this principle, the capillary force that acts on each flow channel can be adjusted.

Alternatively, the intermediate layer 18 may be constituted by a photoresist. In this case, where the intermediate layer 18 is photolithographically formed directly on the second substrate 16, the second substrate 16 and the intermediate layer 18 are aligned with higher accuracy than in the case where the second substrate 16 and the intermediate layer 18 are joined on top of each other.

The third substrate 17, the intermediate layer 18, and the second substrate 16 are not limited to those described above, as long as each of the flow channels has inner wall surfaces at least part of which is hydrophilic. It is preferable to select an appropriate material according to a use of the microanalysis chip 102. For example, in the case of incorporation into the microanalysis chip 102 of a detecting section that carries out optical detection, it is desirable that either or both of the third and second substrates 17 and 16 be made of a transparent or semi-transparent material that emits little light in response to exciting light.

Examples of such a transparent or semi-transparent material include glass, quartz, a thermosetting resin, a thermoplastic resin, a film, etc. Among them, silicon resin, acrylic resin, and styrene resin are preferred in view of transparency and moldability. Examples of a plastic material that emits little light in response to exciting light include a fluorine plastic material such as fluorinated polymethyl methacrylate obtained by replacing a hydrogen atom of polymethyl methacrylate with a fluorine atom, polymethyl methacrylate obtained by using, as additives such as a catalyst and a stabilizer, members that do not produce fluorescence, etc.

On the other hand, in the case of electric control and electric determination in a flow channel of the microanalysis chip 102, it is necessary to form electrodes on the surface of the third or second substrate 17 or 16. Therefore, either or both of the third and second substrates 17 and 16 is/are made of a material capable of electrode formation. Preferred examples of a material capable of electrode formation include glass, quartz, and silicon in view of flatness and workability. Further, for easy manufacture, it is preferable that the electrodes be formed on the second substrate 16, in which no grooves are formed.

(Method for Forming the Flow Channels)

Examples of a method for forming the holes (main flow channel forming hole, first introduction flow channel forming hole, first discharge flow channel forming hole, etc.) and the through-holes in the intermediate layer 18 include a method based on machining, a method based on laser processing, a method based on etching with a chemical or a gas, etc. Alternatively, as mentioned above, a pattern of such holes and through-holes may be formed on a photoresist by using a photolithographic method.

The widths (hole widths or groove widths) of the main flow channel 1, of the first introduction flow channel 2, of the second introduction flow channel 4, and of the first discharge flow channel 3 are set as such dimensions that a solution can permeate into each of the flow channels by solution wettability and capillary force.

It is only necessary that assuming that W1 is the average hole width (average groove width) of the main flow channel 1 and W2 is the average hole width (average groove width) of the first introduction flow channel 2, W2<W1 be satisfied. However, since capillary force is utilized, the widths are set to be approximately 1 μm to 5 mm. Such a configuration makes it possible to, after discharging a solution remaining in the first liquid introduction hole 5, easily and completely discharge the solution out of the main flow channel 1.

It should be noted that each of the flow channels does not need to be constant in width. For example, the main flow channel 1 may be structured to be wide in width only in the part where the reacting and detecting section 13 is provided. Widening the width makes it possible to enlarge the area of the reacting and detecting section 13.

(Explanation of Operation)

The microanalysis chip 102 according to Embodiment 3 allows solutions to flow in a similar way to Embodiment 1 shown in FIG. 3. The microanalysis chip 102 according to the present embodiment makes it possible to carry out quantitative reaction and/or detection on two solutions without using an external pump or the like.

(Immunoassay)

The microanalysis chip 102 shown in FIG. 7 makes it possible to carry out liquid transfer control and quantitative reaction and/or detection on a plurality of solutions without using an external pump or the like. For example, the microanalysis chip 102 shown in FIG. 7 can be utilized for the measurement of antigen concentrations by such an immunoassay as follows: An antigen-antibody reaction is produced by immobilizing an antibody or the like in an inner part of the main flow channel 1 and pouring a mixture of a liquid containing an antigen and a liquid containing an enzyme-labeled antibody; then, an enzyme substrate reaction is produced by pouring a substrate solution, and the amount of the antigen is measured by using a detection electrode to detect the amount of an electrode active substance produced by the enzyme substrate reaction.

The present embodiment uses a similar flow channel structure to Embodiment 1, but may alternatively use a similar flow channel structure to Embodiment 2. In the latter case, it is possible to, without using an external pump or the like, carry out quantitative reaction and/or detection on two solutions and allow all of the other one solution poured to pass through the reacting and detecting section 13.

### Embodiment 4

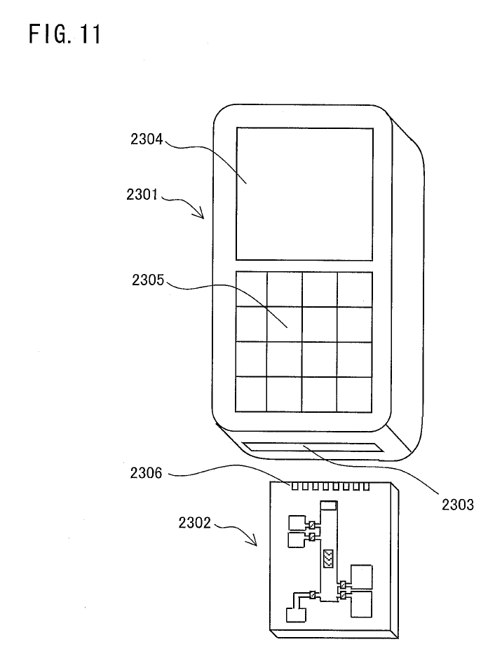

Embodiment 4 relates to a portable handy microanalysis device (analysis device). The content of Embodiment 4 is described with reference to FIG. 11. FIG. 11 is a conceptual diagram for providing a brief overview of a portable handy microanalysis device according to Embodiment 4.

The handy microanalysis device is constituted by a microanalysis chip 2302 and a handy controller (analysis device) 2301 that controls driving of the microanalysis chip 2302. The microanalysis chip 2302 is the same as those microanalysis chips described in Embodiments 1 to 3. Therefore, a detailed description of such a microanalysis chip is omitted here.

As shown in FIG. 11, the handy controller includes a display section 2304, an input section 2305, and a chip loading slot 2303.

The chip loading slot 2303, located at the bottom of the handy controller 2301, is used for inserting an external connection terminal 2015 of the microanalysis chip 2302. Provided in the back of the chip loading slot 2303 is an external input and output terminal (not illustrated) that is electrically connected to the external connection terminal 2306. Insertion of the external connection terminal 2306 of the microanalysis chip into the chip loading slot 2303 causes the external input and output terminal inside of the handy controller 2301 and the external connection terminal of the microanalysis chip 2302 to be electrically connected to each other.

The display section 2304 can display a result of measurement performed (e.g., an amount of a substance detected) in the microanalysis chip 2302.

The input section 2305 receives various data on the basis of which measurement is started and stopped and measurement parameters are specified. The input section 2305 may be structured in the form of a touch panel, for example.

Furthermore, although not illustrated, the handy controller 2301 has incorporated therein an information processing system such as a CPU capable of processing data and an I/O logic circuit that processes input information and output information.

(Explanation of Operation)

The handy controller 2301 and the microanalysis chip 2302 are used as follows: First, the microanalysis chip 2302 is connected to the handy controller 2301. Next, various data are inputted. Then, a measurement start button is pressed, whereby reagent solutions and sample solutions (solutions) put in advance into the microanalysis chip and stopped by the switching valves from flowing into the flow channels start to sequentially enter the flow channels. This causes a predetermined reaction in each flow channel to produce a detectable substance that reaches the detecting section, which emits an electrical signal corresponding to the amount of the substance detected. This electrical signal is outputted to the handy controller 2301 through the external connection terminal 2306.

The signal outputted through the external connection terminal 2306 is received by the handy controller 2301 through the external input terminal electrically connected to the external connection terminal 2306, and is analyzed on the basis of software information stored in advance in the handy controller 2301, so that the amount, type, or the like of the substance detected can be specified.

As the handy controller 2301, a portable electronic device such as a cellular phone or a PDA can be utilized. For example, by providing, with a cellular phone having a computer function, such a chip loading slot as that described above and storing, in the cellular phone, analysis software for processing of data transmitted from the microanalysis chip, the cellular phone can be made to function as a cellular phone in normal times and function as a handy controller 2301 as needed.

An example of a method of operation is as follows: First, the microanalysis chip 2302 is connected to the cellular phone. Next, various data are inputted by pressing buttons on the cellular phone. Then, a button designated as a measurement start button is pressed, whereby reagent solutions and sample solutions prepared in advance in the microanalysis chip 2302 and stopped by the switching valves from flowing into the flow channels start to enter the flow channels. After that, the microanalysis chip 2302 subsequently operates to output, to the cellular phone, an electrical signal corresponding to the amount of a substance detected in the detecting section. The computer in the cellular phone analyzes the signal on the basis of the software, specifies the amount, type, etc. of the substance detected, and causes the display of the cellular phone to show the amount, type, etc. of the substance detected. Further, upon receiving an instruction from an operator, the cellular phone utilized its electrical transmission function to electrically transmit the analytic information to a remote place.

By thus utilizing a portable device, a microanalysis device can be achieved which is excellent in cost performance, user-friendliness, and usability.

It should be noted that it is possible to employ any form or method of signal transmission between an analysis chip and a portable electronic device, as long as the analysis chip and the portable electronic device can exchange electrical signals with each other; in other word, it is not always necessary to use a method that involves the use of such a chip loading slot as that described above.

### EXAMPLES

In the following, the present invention is described by way of examples. It should be noted, however, that the present invention is not to be limited in scope to these examples.

### Example 1

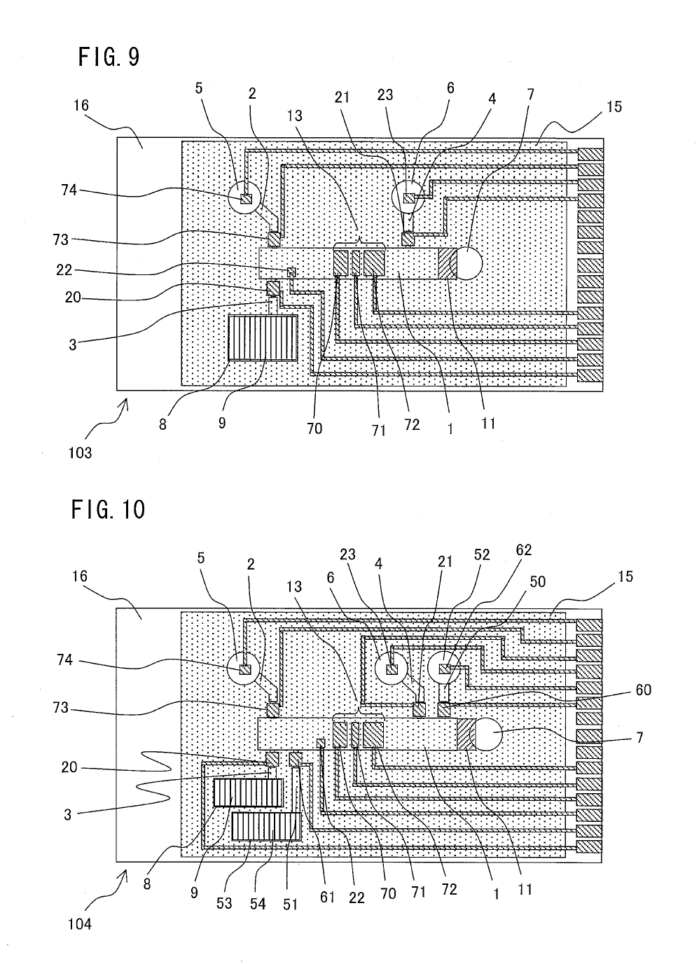

The present example relates to Embodiment 1. FIG. 9 shows a structure of a microanalysis chip 103 according to the present example.

As shown in FIG. 9, the microanalysis chip 103 of the present example includes a main flow channel 1, a first introduction flow channel 2, a first discharge flow channel 3, a second introduction flow channel 4, a first liquid introduction hole 5, a second liquid introduction hole 6, an open hole 7, a first liquid-discharging section 8, and a reacting and detecting section 13.

The first introduction flow channel 2, the first discharge flow channel 3, and the second introduction flow channel 4 are each connected to the main flow channel 1. Further, the first introduction flow channel 2 has one end connected to the first liquid introduction hole 5, the first discharge flow channel 3 as a discharging side connected to the first liquid-discharging section 8, and the second introduction flow channel 4 has one end connected to the second liquid introduction hole 6. Further, the reacting and detecting section 13 is provided in the main flow channel 1, and the main flow channel 1 has one end connected to the open hole 7.

The first introduction flow channel 2 and the third discharge flow channel 3 are connected to the main flow channel 1 at a side of the main flow channel 1 that is opposite to the open hole 7 with respect to the reacting and detecting section 13.

The first introduction flow channel 2, the first discharge flow channel 3, and the second introduction flow channel 4 each include an electrowetting valve constituted by an actuating electrode and a reference electrode.

As with Embodiment 1, the microanalysis chip 103 includes: a first substrate 15 constituted by a PDMS substrate having formed therein depressed grooves for use as parts of the flow channels; and a second substrate 16 constituted by a glass substrate.

The grooves in the first substrate 15 were formed by a resin molding method that involves the use of a mold. The mold was made by (i) photolithographically forming a resist pattern on a silicon substrate and (ii) then etching the resist pattern through a dry-etching process. Into the mold thus made, PDMS (manufactured by Dow Corning Toray Co., Ltd.; SILPOT 184) was poured until it came to have a thickness of 2 mm. The PDMS was cured by heating it at 100° C. for fifteen minutes. The PDMS thus cured was separated from the mold, and was formed into a substrate having a length of 15 mm, a width of 30 mm, and a thickness of 2 mm. In the result, the first substrate 15 was obtained.

The width of the main flow channel 1 in the first substrate 15 was 600 μm. The widths of the first introduction flow channel 2, the first discharge flow channel 3, and the second introduction flow channel 4 in the parts other than those where the actuating electrodes for use as parts of the switching valves were provided were 300 μm each. The widths of the first introduction flow channel 2, the first discharge flow channel 3, and the second introduction flow channel 4 in the parts where the actuating electrodes for use as parts of the switching valves were provided were 50 μm each. The height of each of the flow channels was 50 μm.

The through-holes in the first substrate 15 for use as the open hole, as the first liquid introduction hole 5, as the first liquid introduction hole 5, and as the second liquid introduction hole 52 had a diameter of 2 mm each, and were formed by punching. Further, the first liquid-discharging section 8 had such a shape as to pass through the first substrate 15, and was formed by molding.

The second substrate 16 was fabricated by cutting a glass substrate having a thickness of 600 μm with a dicing saw into a length of 17 mm and a width of 34 mm.

The second substrate was provided in advance with the reacting and detecting section 13, the actuating electrodes 20, 21, and 73 for use as parts of the electrowetting valves, the reference electrodes 22, 23, and 74 for use as parts of the electrowetting valves, the electrode pads 30, the extraction electrodes 34, and the hydrophobic section 11.

A detection working electrode (analyzing section) 70 and a detection counter electrode (analyzing section) 72, which are parts of the reaction and detection section 13, and the actuating electrodes 20, 21, and 73 for use as parts of the electrowetting valves were made by (i) photolithographically patterning a resist, (ii) forming a titanium layer having a thickness of 50 nm and a gold layer having a thickness of 100 nm, and (iii) then patterning the resulting laminate by a lift-off method. The titanium layer was formed by laminating titanium, and the gold layer was formed by laminating gold.

A detection reference electrode (analyzing section) 71, which is a part of the reacting and detecting section 13, and the reference electrodes 22, 23, and 74 for use as parts of the electrowetting valves were made by (i) photolithographically patterning a resist, (ii) forming a silver layer having a thickness of 1 μm, and (iii) then patterning the resulting laminate by a lift-off method. The silver layer was formed by laminating silver. After the reference electrodes had been made, a surface of the silver was chlorinated. In the result, reference electrodes constituted by silver/silver chloride layers were obtained. Chlorination was carried out under conditions where a voltage of +100 mV was applied for fifty seconds to the electrodes in 0.1 M hydrochloric acid.

By connecting the reacting and detecting section 13 thus obtained to a potentiostat, electrochemical measurement of an electrically-active substance introduced into the reacting and detecting section 13 was performed.

Furthermore, hydrophobic films made of tetrafluoroethylene were formed on the actuating electrodes 20, 21, and 73 for use as parts of the electrowetting valves and on the hydrophobic section 11 in the place where the main flow channel 1 is connected to the open hole 7, respectively. The hydrophobic films were formed by (i) photolithographically patterning a resist, (ii) forming a hydrophobic film by coating with tetrafluoroethylene, and (iii) then removing, by a lift-off method, the resist and those portions of the hydrophobic film which had been formed on the resist.

The first and second substrates 15 and 16 thus obtained were joined on top of each other by self-adsorption, and an absorber 9 made of ceramic was placed in the first liquid-discharging section 8. Thus, the microanalysis chip 103 according to Example 1 was completed.

In the present example, the actuating electrodes of the electrowetting valves were each constituted by forming a hydrophobic film on a gold thin film, but may each be alternatively constituted by forming a gold thin film alone. Exposure of a gold surface to natural air causes a thin film (having a contact angle of 60 degrees to 85 degrees) composed of carbon deposits to be formed on the surface. This allows the thin film to function as an actuating electrode.

### Comparative Example 1

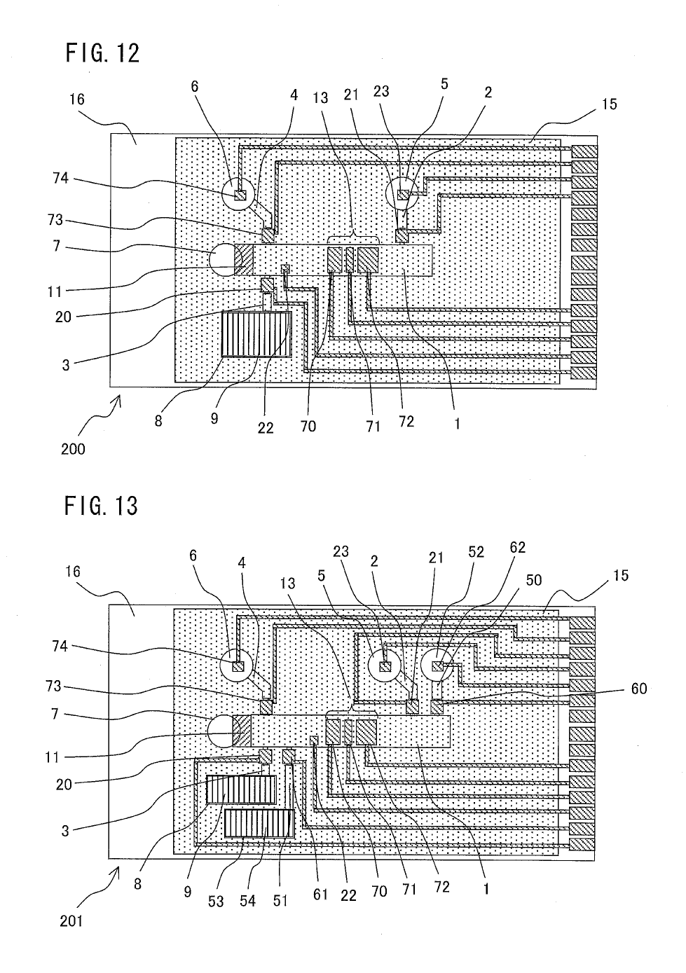

FIG. 12 shows a structure of a microanalysis chip 200 of Comparative Example 1. As shown in FIG. 12, a microanalysis chip 200 according to Comparative Example 1 was fabricated in a similar manner to Example 1, except that the first introduction flow channel 2 was connected to the main flow channel 1 at a side of the main flow channel 1 that is opposite to the first discharge flow channel 3 and the open hole 7 with respect to the reacting and detecting section 13.

(Liquid Transfer Test, Immunoassay 1)

A test was carried out in which solutions were allowed to flow through the microanalysis chip 103 according to Example 1.

First, a mixture (first liquid 40) of a pretreated blood sample and an enzyme-labeled antibody was poured into the first liquid introduction hole 5, and a substrate solution (second liquid 41) was poured into the second liquid introduction hole 6. The amount of each of the liquids poured was 2 μL. The solutions thus poured flowed through the introduction flow channels by a capillary phenomenon, and stopped on reaching the actuating electrodes used as parts of the switching valves provided in the introduction flow channels.

Then, by applying a voltage between the actuating electrode 73 and the reference electrode 74, a fifth switching valve in the first introduction flow channel 2 was opened, so that the first liquid 40 flowed through the first introduction flow channel 2 into the main flow channel 1 toward the open hole 7 by capillary force, and stopped after being charged into the main flow channel 1. The voltage applied was 2.5 V.

Next, by applying a voltage of 2.5 V between the actuating electrode 20 and the reference electrode 22, the first switching valve in the first discharge flow channel 3 was opened, so that the first liquid 40 remaining in the first liquid introduction hole 5 was discharged into the first liquid-discharging section 8 through the first discharge flow channel 3 by capillary force.

Then, the first liquid 40 charged into the main flow channel 1 was discharged into the first liquid-discharging section 8 through the first discharge flow channel 3. Since the first discharge flow channel 3 was connected to the main flow channel 1 at a side opposite of the main flow channel 1 that is opposite to the open hole 7 with respect to the reacting and detecting section 13 and the minimum value of groove widths of the main flow channel 1 was larger than the minimum value of groove widths of the first introduction flow channel 2 and the first discharge flow channel 3, the introduction of air through the open hole 7 was facilitated, so that the first liquid 40 was able to be discharged without remaining in the main flow channel 1.

Further, by constructing the structure to have an absorber 9 provided in the first liquid-discharging section 8, the first liquid 40 was able to be discharged at a higher rate than in the case where it was discharged by capillary force alone. Furthermore, the entrance of the solution into the open hole 7 was able to be prevented by constructing the structure to have a hydrophobic section 11, provided in the place where the main flow channel 1 is connected to the open hole 7, whose outer wall surfaces are wholly or partially hydrophobic. This allowed more stable liquid transfer.

Next, by applying a voltage of 2.5 V between the actuating electrode 21 and the reference electrode 23, the second switching valve in the second introduction flow channel 4 was opened, so that the first liquid 41 flowed through the second introduction flow channel 4 into the main flow channel 1 by capillary force, and stopped after being charged into the main flow channel 1.

Regardless of the amounts in which the first liquid 40 and the second liquid 41 were poured, the first liquid 40 and the second liquid 41 passed in constant amounts through the reacting and detecting section 13 provided in the flow channel 1. This made it possible to carry out quantitative reaction and/or detection, thus making it possible to carry out quantitative reaction and/or detection on the two solutions without using an external pump or the like.

Further, it was possible to carry out a similar liquid transfer operation also in the case of a configuration in which the actuating electrodes of the electrowetting valves were formed by gold thin films alone. This configuration required a lower voltage of 1.0 V to be applied between each of the actuating electrodes and its corresponding reference electrode.

On the other hand, the microanalysis chip 200 of Comparative Example 1 worked in the same manner as Example 1 until the first liquid 40 remaining in the first liquid introduction hole 5 was discharged into the first liquid-discharging section 8. However, while the first liquid 40 charged into the main flow channel 1 was being discharged into the first liquid-discharging section 8, the introduction of air through the open hole 7 caused a portion of the first liquid 40 to remain in the main flow channel 1, with the result that the first liquid 40 was not able to b e stably discharged.

Thus, it was confirmed that the microanalysis chip 103 according to Example 1 allows two solutions to be more stably transferred by capillary force without use of an external pump or the like and to be subjected to quantitative reaction and/or detection.

Next, the measurement of a specific protein by an immunoassay was performed by using the microanalysis chip 103 according to Example 1. In the following description, the symbol of unit “L” denotes “1 (liter)” and the symbol of unit “M” denotes “mol/l (mol/liter)”.

As a specific protein, adiponectine (manufactured by R&D Systems, Inc.; 1065AP) was prepared in the form of a sample liquid of adiponectine in a concentration of 100 ng/mL, and the measurement was performed through the following procedures:

(1) An antibody (manufactured by R&D Systems, Inc.; MAB10651) was immobilized in advance on the detection working electrode 70 provided in the main flow channel 1. The antibody was immobilized by physical adsorption after being incubated at 37° C. for ten minutes.

(2) Mixtures (1 μL, 2.5 μL, and 4 μL) of adiponectine (100 ng/mL) and an enzyme (ALP) labeled antibody (2.5 μg/mL) were prepared. Each of the mixtures was introduced through the first introduction flow channel 2 into the main flow channel 1, stopped for three minutes in the main flow channel 1, and then discharged through the first discharge flow channel 3.

(3) Two microliters of a substrate (pAPP, p-aminophenyl phosphate) solution (1 mM) was introduced through the second introduction flow channel 4 into the main flow channel 1, in which the solution was stopped.

(4) Three minutes after step (4), pAP (p-aminophenol) produced by a reaction between the enzyme and the substrate was subjected to electrochemical detection (cyclic voltammetry) at the electrodes of the detecting section, and the dependence of the peak current value on the amount of a sample of adiponectine was measured.

In the case of the microanalysis chip 103 according to Example 1, the peak current values obtained were substantially constant in the range of sample amounts 1 to 4 μL of the adiponectine solution. On the other hand, in the case of the measurement carried out by using the microanalysis chip 200 according to Comparative Example 1, the current values varied depending on the sample amounts of the adiponectine solution, even with the same concentration of adiponectine.

These results reveal that the present invention makes it possible to easily and quickly perform the measurement of concentrations of a specific protein by an immunoassay, regardless of the amount of a sample to be poured.

### Example 2

The present example relates to Embodiment 2. FIG. 10 shows a structure of a microanalysis chip 104 according to the present example.

The microanalysis chip 104 according to the present Example is identical to Embodiment 1, except that the microanalysis 104 includes a third introduction flow channel 50 and a second discharge flow channel 51.

The microanalysis chip 104 according to Example 2 was fabricated in a similar manner to Embodiment 1.

The second discharge flow channel 51 is connected to the main flow channel 1 at a side of the main flow channel 1 that is opposite to the open hole 7 and the third introduction flow channel 50 with respect to the reacting and detecting section 13.

The third introduction flow channel 50 and the second discharge flow channel 51 each include an electrowetting valve constituted by an actuating electrode and a reference electrode.

The widths of the third introduction flow channel 50 and the second discharge flow channel 51 in the parts other than those where the actuating electrodes for use as parts of the valves were provided were 300 μm each. The widths of the third introduction flow channel 50 and the second discharge flow channel 51 in the parts where the actuating electrodes for use as parts of the valves were provided were 50 μm each. The height of each of the flow channels was 50 μm.

The through-holes for use as the liquid introduction holes had a diameter of 2 mm each. The second liquid-discharging section 53 had such a shape as to pass through the first substrate 15, and an absorber made of ceramic 54 was placed in the second liquid-discharging section 53.

In the present example, the actuating electrodes of the electrowetting valves were each constituted by forming a hydrophobic film on a gold thin film, but may each be alternatively constituted by forming a gold thin film alone. Exposure of a gold surface to natural air causes a thin film (having a contact angle of 60 degrees to 85 degrees) composed of carbon deposits to be formed on the surface. This allows the thin film to function as an actuating electrode.

### Comparative Example 2

FIG. 13 shows a structure of a microanalysis chip 201 of Comparative Example 2. As shown in FIG. 13, a microanalysis chip 201 according to Comparative Example 2 was fabricated in a similar manner to Example 2, except that the first introduction flow channel 2 was connected to the main flow channel 1 at a side of the main flow channel 1 that is opposite to the first discharge flow channel 3 and the open hole 7 with respect to the reacting and detecting section 13.

(Liquid Transfer Test, Immunoassay 2)

A test was carried out in which solutions were allowed to flow through the microanalysis chip 104 according to Example 2.

First, a mixture (first liquid 40) of a pretreated blood sample and an enzyme-labeled antibody, a substrate solution (second liquid 41), and a cleaning solution (third liquid 42) were poured into the first liquid introduction hole 5, the second liquid introduction hole 6, and the third liquid introduction hole 50, respectively. The amount of each of the liquids poured was 2 μL. The solution thus poured flowed through the third liquid introduction hole 50 by a capillary phenomenon, and stopped on reaching the actuating electrode used as parts of the switching valve provided in the third liquid introduction hole 50.

Then, by applying a voltage between the actuating electrode 73 and the reference electrode 74, a fifth switching valve in the first introduction flow channel 2 was opened, so that the first liquid 40 flowed through the first introduction flow channel 2 into the main flow channel 1 toward the open hole 7 by capillary force, and stopped after being charged into the main flow channel 1. The voltage applied was 2.5 V.

Next, by applying a voltage of 2.5 V between the actuating electrode 20 and the reference electrode 22, the first switching valve in the first discharge flow channel 3 was opened, so that the first liquid 40 remaining in the first liquid introduction hole 5 was discharged into the first liquid-discharging section 8 through the first discharge flow channel 3 by capillary force.

Then, the first liquid 40 charged into the main flow channel 1 was discharged into the first liquid-discharging section 8 through the first discharge flow channel 3. Since the first discharge flow channel 3 was connected to the main flow channel 1 at a side of the main flow channel 1 that is opposite to the open hole 7 with respect to the reacting and detecting section 13 and the minimum value of groove widths of the main flow channel 1 was larger than the minimum value of groove widths of the first introduction flow channel 2 and the first discharge flow channel 3, the introduction of air through the open hole 7 was facilitated, so that the first liquid 40 was able to be discharged without remaining in the main flow channel 1. Further, by constructing the structure to have an absorber 9 provided in the first liquid-discharging section 8, the first liquid 40 was able to be discharged at a higher rate than in a case where it is discharged by capillary force alone. Furthermore, the entrance of the solution into the open hole 7 was able to be prevented by constructing the structure to have a hydrophobic section 11, provided in the place where the main flow channel 1 is connected to the open hole 7, whose outer wall surfaces are wholly or partially hydrophobic. This allowed more stable liquid transfer.

Next, by applying a voltage of 2.5 V between the actuating electrode 60 and the reference electrode 62, the third switching valve in the third introduction flow channel 50 was opened, so that the third liquid 42 flowed through the third introduction flow channel 50 into the main flow channel 1 by capillary force, and was charged into the main flow channel 1.

Next, by applying a voltage of 2.5 V between the actuating electrode 61 and the reference electrode 22, the fourth switching valve in the second discharge flow channel 51 was opened, so that those portions of the third liquid 42 in the third introduction flow channel 50 and in the main flow channel 1 were sequentially discharged into the second liquid-discharging section 53 through the second discharge flow channel 51. Since the second discharge flow channel 51 was connected to the main flow channel 1 at a side of the main flow channel 1 that is opposite to the third introduction flow channel 50 with respect to the reacting and detecting section 13, all of the third liquid 42 passed through the reacting and detecting section 13 provided in the main flow channel 1.

Since the second discharge flow channel 51 was connected to the main flow channel 1 at a side of the main flow channel 1 that is opposite to the open hole 7 with respect to the reacting and detecting section 13 and the minimum value of groove widths of the main flow channel 1 was larger than the minimum value of groove widths of the third introduction flow channel 50 and the second discharge flow channel 51, the introduction of air through the open hole 7 was facilitated, so that the second liquid 41 was able to be discharged without remaining in the main flow channel 1. Further, by constructing the structure to have an absorber 54 provided in the second liquid-discharging section 53, the second liquid 41 was able to be discharged a higher rate than in the case where it was discharged by capillary force alone.

Next, by applying a voltage of 2.5 V between the actuating electrode 21 and the reference electrode 23, the second switching valve in the second introduction flow channel 4 was opened, so that the first liquid 41 flowed through the second introduction flow channel 4 into the flow channel 1 by capillary force, and stopped after being charged into the main flow channel 1.

Regardless of the amounts in which the first liquid 40 and the second liquid 41 were poured, the first liquid 40 and the second liquid 41 passed in constant amounts through the reacting and detecting section 13 provided in the flow channel 1. This made it possible to, without using an external pump or the like, carry out quantitative reaction and/or detection on two solutions and allow all of the other one solution to pass through the reacting and detecting section 13.

Further, it was possible to carry out a similar liquid transfer operation also in the case of a configuration in which the actuating electrodes of the electrowetting valves were formed by gold thin films alone. This configuration required a lower voltage of 1.0 V to be applied between each of the actuating electrodes and its corresponding reference electrode.

On the other hand, the microanalysis chip 201 of Comparative Example 2 worked in the same manner as Example 1 until the first liquid 40 remaining in the first liquid introduction hole 5 was discharged into the first liquid-discharging section 8. However, while the first liquid charged into the main flow channel 1 was being discharged into the first liquid-discharging section 8, the introduction of air through the open hole 7 caused a portion of the first liquid 40 to remain in the main flow channel 1, with the result that the first liquid 40 was not able to be stably discharged. Furthermore, while the third liquid 42 was being discharged into the second liquid-discharging section 53, a portion of the third liquid 42 remained in the main flow channel 1, with the result that the third liquid 42 was not able to be stably discharged.

Thus, it was confirmed that the microanalysis chip 104 according to Example 2 allows three solutions to be more stably transferred by capillary force without use of an external pump or the like and allows two solutions to be subjected to quantitative reaction and/or detection.

Next, the measurement of a specific protein by an immunoassay was performed by using the microanalysis chip 104 according to Example 2.

As a specific protein, adiponectine (manufactured by R&D Systems, Inc.; 1065AP) was prepared in the form of a sample liquid of adiponectine in a concentration of 100 ng/mL, and the measurement was performed through the following procedures:

(1) An antibody (manufactured by R&D Systems, Inc.; MAB10651) was immobilized in advance on the detection working electrode 70 provided in the main flow channel 1. The antibody was immobilized by physical adsorption after being incubated at 37° C. for ten minutes.

(2) Mixtures (1 μL, 2.5 μL, and 4 μL) of adiponectine (100 ng/mL) and an enzyme (ALP) labeled antibody (2.5 μg/mL) were prepared. Each of the mixtures was introduced through the first introduction flow channel 2 into the main flow channel 1, stopped for three minutes in the main flow channel 1, and then discharged through the first discharge flow channel 3.

(3) Two microliters of a tris buffer solution for cleaning (THAM (tris hydroxymethyl aminomethane): 10 mM, NaCL: 137 mM, MgCl: 1 mM, PH9.0) was introduced into the main flow channel 1 through the third introduction flow channel 50 and discharged.

(4) Two microliters of a substrate (pAPP, p-Aminophenyl phosphate) solution (1 mM) was introduced through the second introduction flow channel 4 into the main flow channel 1, in which the solution was stopped.

(5) Three minutes after step (4), p AP (p-Aminophenol) produced by a reaction between the enzyme and the substrate was subjected to electrochemical detection (cyclic voltammetry) at the electrodes of the detecting section, and the dependence of the peak current value on the amount of a sample of adiponectine was measured.

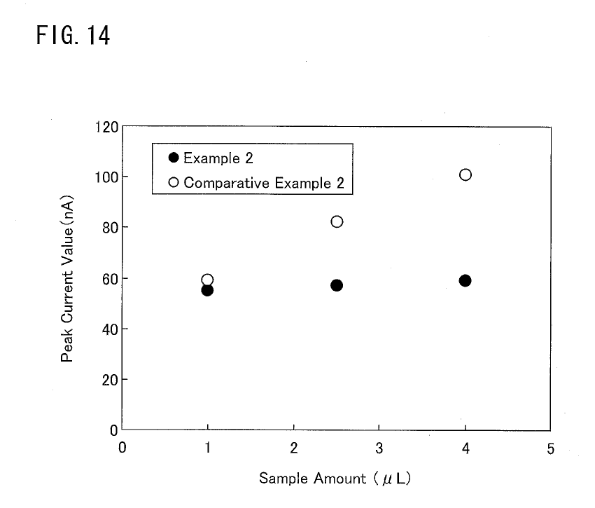

FIG. 14 shows results of the measurement thus performed. The black dots in the drawing represent results of the measurement of peak current values by the microanalysis chip 104 according to Example 2. The current values thus obtained were substantially constant in the range of sample amounts 1 to 4 μL of the adiponectine solution. On the other hand, the white dots in the drawing represent results of the measurement of peak current values by the microanalysis chip 201 according to Comparative Example 2, in which case the current values varied depending on the sample amounts of the adiponectine solution, even with the same concentration of adiponectine.

These results reveal that the present invention makes it possible to easily and quickly perform the measurement of concentrations of a specific protein by an immunoassay, regardless of the amount of a sample to be poured.

It should be noted that the present invention can also be expressed as follows:

That is, a microanalysis chip according to the present invention may include, at least: a main flow channel, connected to an open hole open to an outside, which includes a reacting section and/or a detecting section; a first introduction flow channel connected to a first liquid introduction hole and to the main flow channel; and a first discharge flow channel connected to a first liquid-discharging section and to the main flow channel, the first introduction flow channel and the first discharge flow channel being connected to the main flow channel at a side of the main flow channel that is opposite to the open hole with respect to the reacting section and/or the detection section.

Further, the microanalysis chip may further include at least a second introduction flow channel connected to a second liquid introduction hole open to the outside and connected to the main flow channel, wherein: the first discharge flow channel may be provided with a first switching valve that regulates a flow of a liquid, and the second introduction flow channel may be provided with a second switching valve that regulates a flow of a liquid.

Further, the microanalysis chip may further include a third introduction flow channel connected to a third liquid introduction hole open to the outside and connected to the main flow channel, wherein: the third introduction flow channel may be provided with a third switching valve that regulates a flow of a liquid; and the third introduction flow channel may be connected to the main flow channel at a side of the main flow channel that is opposite to the first discharge flow channel with respect to the reacting section and/or the detecting section in a direction that the liquid flows.

Further, the microanalysis chip may be configured such that each of the flow channels has inner wall surfaces at least part of which is hydrophilic so that liquid transfer is carried out with capillary force as driving force.

Further, the microanalysis chip may further include an absorber provided in the first liquid-discharging section.

Further, the microanalysis chip may further include at least a second discharge flow channel connected to a second liquid-discharging section open to the outside and connected to the main flow channel, wherein the second discharge flow channel may be provided with a fourth switching valve that regulate a flow of a liquid; and the second discharge flow channel may be connected to the main flow channel at a side of the main flow channel that is opposite to the open hole and the third introduction flow channel with respect to the reacting section and/or the detecting section in a direction that the liquid flows.

Further, the microanalysis chip may further include an absorber provided in the second liquid-discharging section.

Further, the microanalysis chip may further include at least a first substrate having formed therein grooves for use as parts of the flow channels and a second substrate that covers the first substrate, wherein each of the flow channels may be constituted by joining the first substrate and the second substrate on top of each other.

Further, the microanalysis chip may be configured such that each of the grooves formed in the first substrate may be a depressed groove having three wall surfaces.

Further, the microanalysis chip may be configured such that the first substrate is made of a hydrophobic material and the second substrate is made of a hydrophilic material.

Further, the microanalysis chip may be configured such that the first substrate is made of polydimethylsiloxane and the second substrate is made of glass.

Further, the microanalysis chip may be structured such that assuming W1 is the average groove width of the main flow channel and W2 is the average groove width of the first introduction flow channel, W2<W1 holds.

Further, the microanalysis chip may further include at least an intermediate layer having formed therein side wall portions for use as parts of the flow channels and second and third substrates that cover both sides of the intermediate layer, respectively, to close the grooves, wherein each of the flow channels may be constituted by joining the third substrate, the intermediate layer, and the second substrate on top of one another.

Further, the microanalysis chip may be configured such that the intermediate layer is made of a hydrophobic material.

Further, the microanalysis chip may be structured such that assuming W1 is the average groove width of the main flow channel and W2 is the average groove width of the first introduction flow channel, W2<W1 holds.

Further, the microanalysis chip may further include a hydrophobic section whose outer wall surfaces are wholly or partially hydrophobic, the hydrophobic section being provided in a place where the main flow channel is connected to the open hole.

Further, the microanalysis chip may be configured such that each of the switching valves is an electrowetting valve.

Further, the microanalysis chip may be configured such that each of the switching valves has an actuating electrode constituted by a conducting thin film.

Further, the microanalysis chip may be configured such that the each of the switching valves has an actuating electrode constituted by a conducting thin film and a thin film formed on the conducting thin film.

Further, the microanalysis chip may be configured such that the thin film has a thickness of 100 nm or smaller.

Further, the microanalysis chip may be configured such that the thin film has a contact angle of 80 degrees or larger with respect to pure water at 25° C. and a specific resistance of 18 kΩ·cm.

Further, the microanalysis chip may be configured such that the thin film is made of a fluorine-containing substance or a substance including a thiol group.

Further, a microanalysis device according to the present invention may include such a microanalysis chip as an essential element.

Further, a microanalysis method according to the present invention uses such a microanalysis chip, including the steps of: causing a solution introduced through the first liquid introduction hole to flow through the first introduction flow channel into the main flow channel toward the open hole and be charged into the main flow channel; then causing a solution remaining in the first liquid introduction hole to be discharged into the first liquid-discharging section through the first discharge flow channel; and then causing the solution charged into the main flow channel to be discharged into the first liquid-discharging section through the first discharge flow channel.

Further, a method for transferring a solution according to the present invention is a method for transferring a solution by using a microanalysis chip including (i) a main flow channel having one end connected to an open hole open to an outside, (ii) a first introduction flow channel having one end connected to a flow channel inner surface of the main flow channel and having formed at the other end thereof a first liquid introduction hole into which a solution to be introduced into the main flow channel is poured, (iii) a first discharge flow channel through which a solution introduced into the main flow channel through the first introduction flow channel is able to be discharged, (iv) a first switching valve provided in the first discharge flow channel so as to regulate a flow of a solution, (v) a second introduction flow channel having one end connected to the flow channel inner surface of the main flow channel and having formed at the other end thereof a second liquid introduction hole into which a solution to be introduced into the main flow channel is poured, (vi) a second switching valve provided in the second discharge flow channel so as to regulate a flow of a solution, (vii) a third introduction flow channel having one end connected to the flow channel inner surface of the main flow channel and having formed at the other end thereof a third liquid introduction hole into which a solution to be introduced into the main flow channel is poured, (viii) a third switching valve provided in the third discharge flow channel so as to regulate a flow of a solution, (ix) a second discharge flow channel through which a solution introduced into the main flow channel through the third introduction flow channel is able to be discharged, (x) a fourth switching valve provided in the second discharge flow channel so as to regulate a flow of a solution, and (xi) an analyzing section which analyzes a property of a solution introduced into the main flow channel, the first introduction flow channel and the first discharge flow channel being both provided at a side of the main flow channel that is opposite to the open hole with respect to the analyzing section, the third introduction flow channel being provided at a side of the main flow channel that is opposite to the first discharge flow channel with respect to the analyzing section, the method including: a first introducing step of pouring solutions into the first liquid introduction hole, the second liquid introduction hole, and the third liquid introduction hole, respectively, and introducing, through the first introduction flow channel into the main flow channel, the solution poured into the first liquid introduction hole; a first charging step of charging, into a space between the one end of the main flow channel and the open hole, the solution introduced into the main flow channel in the first introducing step; a first discharging step of, by opening the first switching valve to facilitate discharge of the solution introduced into the main flow channel, discharging, through the first discharge flow channel, a solution remaining in the first liquid introduction hole; a second discharging step of discharging the solution charged into the space between the one end of the main flow channel and the open hole; a second introducing step of, by closing the first switching valve and opening the third switching valve, introducing, through the third introduction flow channel into the main flow channel, the solution poured into the third liquid introduction hole; a second charging step of charging, into the space between the one end of the main flow channel and the open hole, the solution introduced into the main flow channel in the second introducing step; a third discharging step of, by opening the fourth switching valve, discharging, through the second discharge flow channel, the solution charged in the second charging step and a solution remaining in the third liquid introduction hole; and a third introducing step of, by closing the fourth switching valve and opening the second switching valve, introducing, through the second introduction flow channel into the main flow channel, the solution poured into the second liquid introduction hole.

Further, the present invention can also be expressed as follows:

Further, the microanalysis chip of the present invention may be configured such that the maim flow channel, the first introduction flow channel, and the first discharge flow channel each have flow channel inner surfaces at least part of which is made of a hydrophilic material so that a liquid is able to be transferred with capillary force as driving force.

According to the foregoing configuration, the maim flow channel, the first introduction flow channel, and the first discharge flow channel are each capable of liquid transfer by capillary force. This make it unnecessary to use an external source of power such as such as a pump to transfer a liquid through any one of the flow channels, thus making it possible, for example, to reduce the size of, reduce the weight of, and simplify the whole of the after-mentioned analysis device including such a microanalysis chip.

Further, the microanalysis chip of the present invention may further include an absorber that absorbs a solution, the absorber being provided in a first liquid-discharging section into which a solution is discharged through the first discharge flow channel.

The foregoing configuration makes it possible to easily and completely discharge a solution out of the main flow channel without using an external source of power such as a pump. Further, the retention of a solution by the absorber makes it possible to prevent the solution from flowing out of the microanalysis chip.

Incidentally, in a configuration in which a solution is charged into an inner part of the main flow channel that extends from one end to the open hole, there is such a problem that the shape of a gas-liquid interface by the surface tension of the solution varies depending on conditions such as the degree of hydrophobicity or hydrophilicity of flow channel inner surfaces leading to the open hole and the viscosity of the solution.

In order to solve such a secondary problem, the microanalysis chip of the present invention may further include a damming section that dams a solution, the damming section being provided between the one end and the analyzing section.

According to the foregoing configuration, the solution charged into the main flow channel is surely dammed by the damming section. This makes it possible to more highly precisely carry out a quantitative analysis of the solution charged into a space between the end of the analyzing section to the damming section.

Further, the microanalysis chip of the present invention may be configured such that the damming section is made of a hydrophobic material.

According to the foregoing configuration, the damming section is made of a hydrophobic material. This allows prevention of the entrance of a solution into the open hole, thus making it possible to more stably carry out liquid transfer.

Further, the microanalysis chip of the present invention may be configured such that the damming section is constituted by an electrowetting valve.

An electrowetting valve can regulate the flow of a liquid with a minute and simple structure, and as such, is suitable as a switching valve for use in a micro flow channel.

Therefore, the foregoing configuration makes it possible to select whether to dam the solution at the damming section, i.e., whether to charge the liquid up to the damming section or up to the open hole. This makes it possible to carry out a quantitative analysis by selecting an amount of a liquid for analytical use from among two amounts of liquid as needed.

It should be noted that the electrowetting valve is preferably configured to have at least an actuating electrode and a reference electrode, and may further include a counter electrode. As will be mentioned later, the actuating electrode of such a valve may for example be constituted by a conducting thin film or be constituted by a conducting thin film and a thin film provided on the conducting thin film and made of a different material from the conduction thin film.

Further, the microanalysis chip of the present invention may further include a second introduction flow channel through which a solution is introduced into the main flow channel, wherein: the first discharge flow channel includes a first switching valve that regulates a flow of a solution; and the second introduction flow channel includes a second switching valve that regulates a flow of a liquid.

According to the foregoing configuration, for example, in a case where the first introduction flow channel includes a first liquid introduction hole into which a solution in poured, a solution remaining in the first liquid introduction hole is discharged through the first discharge flow channel by opening the first switching valve after the solution has been charged into the main flow channel and has stopped.

Further, as mentioned above, the first introduction flow channel and the first discharge flow channel are both provided at a side of the main flow channel that is opposite to the open hole with respect to the analyzing section. Therefore, the solution charged into the main flow channel is then discharged without remaining in the main flow channel

Next, by closing the first switching valve and opening the second switching valve provided in the second introduction flow channel, the solution is introduced into the main flow channel through the second introduction flow channel. Therefore, in the case of an analysis that is carried out by using a plurality of microanalysis chips, the amount of a solution that passes through the analyzing section in the main flow channel is constant even if the amount of a solution that is introduced through the second introduction flow channel varies from one microanalysis chip to another.

It should be noted that although it is preferable that the second introduction flow channel be provided at a side of the main flow channel that is opposite to the open hole with respect to the analyzing section, the second introduction flow channel may be provided at the same side of the main flow channel as the open hole with respect to the analyzing section.

In the former case, it is possible to carry out a quantitative analysis of two solutions in the same amounts of the solutions.

In the latter case, that portion of the solution introduced through the second introduction flow channel which passes through the analyzing section is a solution that is charged into the space extending from an end of the analyzing section that faces the open end to the other end of the main flow channel (with the one end being an end of the main flow channel that faces the open hole), but the amount of a solution that passes through the analyzing section in the main flow channel stays constant even if the amount of a solution that is introduced through the second introduction flow channel varies from one microanalysis chip to another.

Further, the microanalysis chip of the present invention may further include a third introduction flow channel through which a solution is introduced into the main flow channel, wherein the third introduction flow channel includes a third switching valve that regulates a flow of a liquid, the third introduction flow channel being provided at a side of the main flow channel that is opposite to the first discharge flow channel with respect to the analyzing section.

According to the foregoing configuration, the solution is introduced into the main flow channel through the first introduction flow channel, and is charged into a space between the one end of the main flow channel and the open hole. Having reached the open hole, the solution stops on forming, because of its surface tension, a gas-liquid interface of any one of the aforementioned shapes.

After that, by opening the first switching valve, the solution remaining in the first liquid introduction hole is discharged through the first discharge flow channel. Further, as mentioned above, the first introduction flow channel and the first discharge flow channel are both provided at a side of the main flow channel that is opposite to the open hole with respect to the analyzing section. Therefore, the solution charged into the main flow channel is then discharged without remaining in the main flow channel.

Next, by closing the first switching valve and opening the third switching valve provided in the third introduction flow channel, the solution is introduced into the main flow channel through the third introduction flow channel, and is charged into the main flow channel.

After that, by opening the first switching valve, the solution charged into the main flow channel is discharged through the first discharge flow channel without remaining in the main flow channel.

Next, in a case where the second introduction flow channel and the second switching valve as mentioned above are included, by opening the second switching valve provided in the second introduction flow channel, the solution is introduced into the main flow channel through the second introduction flow channel, and stops after being charged into the main flow channel.

The foregoing configuration makes it possible to transfer three solutions in sequence and to carry out a quantitative analysis of two solutions in the same amounts of the solutions.

Further, the microanalysis chip of the present invention may further include a second discharge flow channel through which the solution introduced into the main flow channel is discharged, wherein the second discharge flow channel includes a fourth switching valve that regulates a flow of a liquid, the second discharge flow channel being provided at a side of the main flow channel that is opposite to the third introduction flow channel with respect to the analyzing section.

According to the foregoing configuration, the microanalysis chip has two discharge flow channels. Therefore, a solution introduced through the first introduction flow channel and a solution introduced through the third introduction flow channel are discharged through the first discharge flow channel and the second flow discharge channel, respectively.

Therefore, by providing separate discharge flow channels, the operation of discharge of a solution through each discharge flow channel needs only be carried out once. This reduces the amount of a solution that is discharged through each discharge flow channel, thus making it possible to more stably discharge the solution.

Further, the microanalysis chip of the present invention may further include an absorber that absorbs a solution, the absorber being provided in a second liquid-discharging section into which a solution is discharged through the second discharge flow channel.

The foregoing configuration makes it possible to stably discharge the solution through the second discharge flow channel without using an external source of power such as a pump. Further, the retention of the solution by the absorber makes it possible to prevent the solution from flowing out of the microanalysis chip.

Further, the microanalysis chip of the present invention may be configured such that at least one of the first, second, third, and fourth switching valves is constituted by an electrowetting valve.

As mentioned above, an electrowetting valve can regulate the flow of a liquid with a minute and simple structure, and as such, is suitable as a switching valve for use in a micro flow channel.

Therefore, the foregoing configuration makes it possible to downsize the microanalysis chip.

Further, the microanalysis chip of the present invention may be configured such that the electrowetting valve includes an electrode constituted by a conducting thin film.

According to the foregoing configuration, the electrowetting valve is formed by a conducting thin film. This makes it possible to keep to the minimum the influence of the thickness of an electrode on the transfer of a liquid through a flow channel.

Further, the microanalysis chip of the present invention may further include a thin film provided on the electrode, the thin film being made of a different material from the conducting thin film.

According to the foregoing configuration, by providing, on the electrode, a thin film made of a different material from the electrode, the electrode can be formed to have a combination of advantageous properties such as the conductivity of the metal material of which the electrode is made and the hydrophobicity of the thin film.

Further, the microanalysis chip of the present invention may be configured such that the thin film has a thickness of 100 nm or smaller.

According to the foregoing configuration, the thin film has a thickness of 100 nm or smaller. This makes it possible to achieve a reduction in voltage necessary for the operation of the electrowetting valve, thus making it possible to downsize an analysis device including the microanalysis chip.

Further, the microanalysis chip of the present invention may be configured such that the thin film has a contact angle of 80 degrees or larger with respect to pure water at normal temperature.

According to the foregoing configuration, the thin film has a contact angle of 80 degrees or larger with respect to pure water at normal temperature. By thus employing, as the thin film, a substance having a larger contact angle than the material for the conducting thin film used in the electrode, the solution can be surely stopped when no voltage is applied. This makes it possible to stably operate the electrowetting valve.

Specifically, it is preferable that the normal temperature be approximately 25° C. and the pure water have a specific resistance of approximately 18 kΩ·cm.

Further, the microanalysis chip of the present invention may be configured such that the thin film is made of either a substance containing fluorine or a substance having a thiol group.

According to the foregoing configuration, by using such a substance as the material for the thin film, the thin film can be made to have a contact angle of larger than 90 degrees on the actuating electrode and exhibit a high hydrophobicity. This makes it easy to stop a liquid at the valve when no voltage is applied, thus making it possible to more stably carry out the valve operation.

Further, the microanalysis chip of the present invention may further include: a first substrate having formed therein at least a main flow channel forming groove by which the main flow channel is constituted, a first introduction flow channel forming groove by which the first introduction flow channel is constituted, and a first discharge flow channel forming groove by which the first discharge flow channel is constituted; and a second substrate that seals the main flow channel forming groove formed in the first substrate, the first introduction flow channel forming groove formed in the first substrate, and the first discharge flow channel forming groove formed in the first substrate.

Incidentally, it is in general difficult to form intricate flow channels by fine tubes such as capillary tubes. However, by forming, as in the foregoing configuration, capillary tubes (flow channels) sealing, with the second substrate, the grooves formed in the first substrate, such intricate flow channels are easily created. This makes it possible to easily manufacture the microanalysis chip.

Further, the microanalysis chip of the present invention may further include: a flow channel forming layer having formed therein at least a main flow channel forming hole by which the main flow channel is constituted, a first introduction flow channel forming hole by which the first introduction flow channel is constituted, and a first discharge flow channel forming hole by which the first discharge flow channel is constituted; a third substrate provided on one side of the flow channel forming layer so as to seal the main flow channel forming hole formed in the flow channel forming layer, the first introduction flow channel forming hole formed in the flow channel forming layer, and the first discharge flow channel forming hole formed in the flow channel forming layer; and a fourth substrate provided on on the other side of the flow channel forming layer so as to seal the main flow channel forming hole formed in the flow channel forming layer, the first introduction flow channel forming hole formed in the flow channel forming layer, and the first discharge flow channel forming hole formed in the flow channel forming layer.

As in the foregoing configuration, it is easy to provide the flow channel forming holes in the flow channel forming layer and sandwich the flow channel forming layer between the substrates on both sides of the flow channel forming layer. This makes it possible to easily manufacture the microanalysis chip.

Further, the microanalysis chip of the present invention may be configured such that the main flow channel, the first introduction flow channel, and the first discharge flow channel each has a rectangular cross-section.

According to the foregoing configuration, the grooves formed in the first substrate or the holes formed in the flow channel forming layer serve as depressed grooves or holes each having three flow channel inner surfaces (inner wall surfaces). It is extremely easy to form, in a surface of a substrate, depressed grooves or holes each having three flow channel inner surfaces. This makes it possible to more easily manufacture the microanalysis chip.

Further, the microanalysis chip of the present invention may be configured such that: the first substrate is made of a hydrophobic material; and the second substrate is made of a hydrophilic material.

According to the foregoing configuration, the flow channel inner surfaces of the grooves in the first substrate are hydrophobic in each flow channel. This makes it possible to prevent leakage of a liquid through the joint between the first substrate and the second substrate.

Further, since each of the flow channels can be characterized to increase in hydrophilicity of the entire inner surfaces as it becomes wider in groove width, it becomes possible to design a wider groove width for the main flow channel without impairing hydrophilicity and increase the area of the analyzing section.

Further, the microanalysis chip of the present invention may be configured such that: the hydrophobic material of which the first substrate is made is polydimethylsiloxane; and the hydrophilic material of which the second substrate is made is glass.

Polydimethylsiloxane is hydrophobic, and glass is hydrophilic. Therefore, according to the foregoing configuration, the flow channel inner surfaces of the grooves in the first substrate are hydrophobic in each flow channel. This makes it possible to prevent leakage of a liquid through the joint between the first substrate and the second substrate.

Further, it is possible to design a wider groove width for the main flow channel, and it becomes possible to increase the area of the analyzing section.

Further, the microanalysis chip of the present invention may be configured such that the main flow channel forming groove has a larger average groove width than the first introduction flow channel forming groove.

The foregoing configuration makes it possible to, after a solution has been charged into the main channel, easily and completely discharge the solution out of the main flow channel.

Further, the microanalysis chip of the present invention may be configured such that the flow channel forming layer is made of a hydrophobic material.

According to the foregoing configuration, the wall surfaces of the holes formed in the flow channel forming layer are hydrophobic. This makes it possible to prevent leakage of a liquid through the joint between the substrates. Further, it is possible to design a wider hole width for the main flow channel, and it becomes possible to increase the area of the analyzing section.

Further, the microanalysis chip of the present invention may be configured such that the flow channel forming hole has a larger average hole width than the first introduction flow channel forming hole.

The foregoing configuration makes it possible to, after a solution has been charged into the main channel, easily and completely discharge the solution out of the main flow channel without remaining in the main flow channel.

Further, an analysis device may include such a microanalysis chip.

The foregoing configuration makes it possible to provide an analysis device capable of quantitatively weighing out a solution with a simple configuration and, while keeping a flow channel charged with the solution thus weighed out, analyzing the solution.

As described above, the present invention can provide a microanalysis chip having a flow channel structure that makes it possible to quantitatively weight out a small amount of a solution with a simple configuration without requiring an external source of power such as a pump. In particular, a microanalysis chip of the present invention having switching valves incorporated therein is of a simple structure and yet is capable of quantitatively handling each solution used and carrying out an accurate analysis, and as such, is extremely useful. A microanalysis chip according to the present invention is extremely useful for simplification and downsizing of microanalysis chips and devices for use in the medical field, the biochemical field, the field of measurement of allergens and the like, etc., and as such, have a great value of industrial applicability.

[Additional Matters]

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention can be used for simplification and downsizing of analysis devices in the medical field, the biochemical field, the field of measurement of allergens and the like, etc.

### REFERENCE SIGNS LIST

1 Main flow channel
2 First introduction flow channel (introduction flow channel)
3 First discharge flow channel (discharge flow channel)
4 Second introduction flow channel
5 First liquid introduction hole (liquid introduction hole)
6 Second liquid introduction hole
7 Open hole
8 First liquid-discharging section
53 Second liquid-discharging section
9, 54 Absorber
11 Hydrophobic section (damming section)
13 Reacting and detecting section (analyzing section)
15 First substrate
16 Second substrate (third substrate)
17 Third substrate (fourth substrate)
18 Intermediate layer (flow channel forming layer)
20 Actuating electrode (electrode, first switching valve, electrowetting valve)
21 Actuating electrode (electrode, second switching valve, electrowetting valve)
60 Actuating electrode (electrode, third switching valve, electrowetting valve)
61 Actuating electrode (electrode, fourth switching valve, electrowetting valve)
73 Actuating electrode
22 Reference electrode (electrode, first switching valve, fourth switching valve, electrowetting valve)
23 Reference electrode (electrode, second switching valve, electrowetting valve)
62 Reference electrode (electrode, third switching valve, electrowetting valve)
74 Reference electrode
40 First liquid (solution)
41 Second liquid (solution)
42 Third liquid (solution)
50 Third introduction flow channel
51 Second discharge flow channel
52 Third liquid introduction hole
70 Detection working electrode (analyzing section)
71 Detection reference electrode (analyzing section)
72 Detection counter electrode (analyzing section)
100 Microanalysis chip
101 Microanalysis chip
102 Microanalysis chip
103 Microanalysis chip (Example 1)
104 Microanalysis chip (Example 2)
200 Microanalysis chip (Comparative Example 1)
201 Microanalysis chip (Comparative Example 2)
2301 Handy controller (analysis device)
2302 Microanalysis chip

1. A microanalysis chip comprising:
a main flow channel having one end connected to an open hole open to an outside;
a first introduction flow channel through which a solution is introduced into the main flow channel;
a first discharge flow channel through which a solution introduced into the main flow channel is discharged; and
an analyzing section provided in the main flow channel so as to analyze a property of the solution introduced into the main flow channel,
the first introduction flow channel and the first discharge flow channel being both provided at a side of the main flow channel that is opposite to the open hole with respect to the analyzing section.

2. The microanalysis chip as set forth in claim 1, wherein the maim flow channel, the first introduction flow channel, and the first discharge flow channel each have flow channel inner surfaces at least part of which is made of a hydrophilic material so that a liquid is able to be transferred with capillary force as driving force.

3. The microanalysis chip as set forth in claim 1, further comprising an absorber that absorbs a solution, the absorber being provided in a first liquid-discharging section into which a solution is discharged through the first discharge flow channel.

4. The microanalysis chip as set forth in claim 1, further comprising a damming section that dams a solution, the damming section being provided between the one end and the analyzing section.

5. The microanalysis chip as set forth in claim 4, wherein the damming section is made of a hydrophobic material.

6. The microanalysis chip as set forth in claim 4, wherein the damming section is constituted by an electrowetting valve.

7. The microanalysis chip as set forth in claim 1, further comprising a second introduction flow channel through which a solution is introduced into the main flow channel, wherein:
the first discharge flow channel includes a first switching valve that regulates a flow of a solution; and
the second introduction flow channel includes a second switching valve that regulates a flow of a liquid.

8. The microanalysis chip as set forth in claim 7, further comprising a third introduction flow channel through which a solution is introduced into the main flow channel, wherein
the third introduction flow channel includes a third switching valve that regulates a flow of a liquid,
the third introduction flow channel being provided at a side of the main flow channel that is opposite to the first discharge flow channel with respect to the analyzing section.

9. The microanalysis chip as set forth in claim 8, further comprising a second discharge flow channel through which the solution introduced into the main flow channel is discharged, wherein
the second discharge flow channel includes a fourth switching valve that regulates a flow of a liquid,
the second discharge flow channel being provided at a side of the main flow channel that is opposite to the third introduction flow channel with respect to the analyzing section.

10. The microanalysis chip as set forth in claim 9, further comprising an absorber that absorbs a solution, the absorber being provided in a second liquid-discharging section into which a solution is discharged through the second discharge flow channel.

11. The microanalysis chip as set forth in claim 9, at least one of the first, second, third, and fourth switching valves is constituted by an electrowetting valve.

12.-16. (canceled)

17. The microanalysis chip as set forth in claim 1, further comprising:
a first substrate having formed therein at least a main flow channel forming groove by which the main flow channel is constituted, a first introduction flow channel forming groove by which the first introduction flow channel is constituted, and a first discharge flow channel forming groove by which the first discharge flow channel is constituted; and
a second substrate that seals the main flow channel forming groove formed in the first substrate, the first introduction flow channel forming groove formed in the first substrate, and the first discharge flow channel forming groove formed in the first substrate.

18. The microanalysis chip as set forth in claim 1, further comprising:
a flow channel forming layer having formed therein at least a main flow channel forming hole by which the main flow channel is constituted, a first introduction flow channel forming hole by which the first introduction flow channel is constituted, and a first discharge flow channel forming hole by which the first discharge flow channel is constituted;
a third substrate provided on one side of the flow channel forming layer so as to seal the main flow channel forming hole formed in the flow channel forming layer, the first introduction flow channel forming hole formed in the flow channel forming layer, and the first discharge flow channel forming hole formed in the flow channel forming layer; and
a fourth substrate provided on the other side of the flow channel forming layer so as to seal the main flow channel forming hole formed in the flow channel forming layer, the first introduction flow channel forming hole formed in the flow channel forming layer, and the first discharge flow channel forming hole formed in the flow channel forming layer.

19. The microanalysis chip as set forth in claim 17, wherein the main flow channel, the first introduction flow channel, and the first discharge flow channel each has a rectangular cross-section.

20. The microanalysis chip as set forth in claim 17, wherein:
the first substrate is made of a hydrophobic material; and
the second substrate is made of a hydrophilic material.

21. (canceled)

22. The microanalysis chip as set forth in claim 17, wherein the main flow channel forming groove has a larger average groove width than the first introduction flow channel forming groove.

23. The microanalysis chip as set forth in claim 18, wherein the flow channel forming layer is made of a hydrophobic material.

24. (canceled)

25. An analysis device comprising a microanalysis chip as set forth in claim 1.

26. A method for transferring a solution by using a microanalysis chip including (i) a main flow channel having one end connected to an open hole open to an outside, (ii) an introduction flow channel having one end connected to a flow channel inner surface of the main flow channel and having formed at the other end thereof a liquid introduction hole into which a solution to be introduced into the main flow channel is poured, (iii) a discharge flow channel through which a solution introduced into the main flow channel through the introduction flow channel is able to be discharged, and (iv) an analyzing section provided in the main flow channel so as to analyze a property of the solution introduced into the main flow channel, the introduction flow channel and the discharge flow channel being both provided at a side of the main flow channel that is opposite to the open hole with respect to the analyzing section, the method comprising:
an introducing step of pouring a solution into the liquid introduction hole and introducing, through the introduction flow channel into the main flow channel, the solution thus poured;
a charging step of charging, into a space extending from the one end of the main flow channel to the open hole, the solution introduced into the main flow channel in the introducing step;
a first discharging step of discharging a solution remaining in the liquid introduction hole; and
a second discharging step of discharging the solution charged into the space extending from the one end of the main flow channel to the open hole.

27. A method for transferring a solution by using a microanalysis chip including (i) a main flow channel having one end connected to an open hole open to an outside, (ii) a first introduction flow channel having one end connected to a flow channel inner surface of the main flow channel and having formed at the other end thereof a first liquid introduction hole into which a solution to be introduced into the main flow channel is poured, (iii) a first discharge flow channel through which a solution introduced into the main flow channel through the first introduction flow channel is able to be discharged, (iv) a first switching valve provided in the first discharge flow channel so as to regulate a flow of a solution, (v) a second introduction flow channel having one end connected to the flow channel inner surface of the main flow channel and having formed at the other end thereof a second liquid introduction hole into which a solution to be introduced into the main flow channel is poured, (vi) a second switching valve provided in the second discharge flow channel so as to regulate a flow of a solution, and (vii) an analyzing section provided in the main flow channel so as to analyze a property of the solution introduced into the main flow channel, the first introduction flow channel and the first discharge flow channel being both provided at a side of the main flow channel that is opposite to the open hole with respect to the analyzing section, the method comprising:
a first introducing step of pouring solutions into the first liquid introduction hole and the second liquid introduction hole, respectively, and introducing, through the first introduction flow channel into the main flow channel, the solution poured into the first liquid introduction hole;
a first charging step of charging, into a space between the one end of the main flow channel and the open hole, the solution introduced into the main flow channel in the first introducing step;
a first discharging step of, by opening the first switching valve to facilitate discharge of the solution introduced into the main flow channel, discharging a solution remaining in the first liquid introduction hole;
a second discharging step of discharging the solution charged into the space extending from the one end of the main flow channel to the open hole;
a second introducing step of, by closing the first switching valve and opening the second switching valve, introducing, through the second introduction flow channel into the main flow channel, the solution poured into the second liquid introduction hole; and
a second charging step of charging, into the space extending from the one end of the main flow channel to the open hole, the solution introduced into the main flow channel in the second introducing step.

28. (canceled)
